(19) United States
(12) Patent Application Publication
(10) Pub. No.: US 2013/0186362 A1
(43) Pub. Date: Jul. 25, 2013

(54) LASER IGNITION SYSTEM

(71) Applicants: Kenji Kanehara, Toyohashi-city (JP); Nicolaie Pavel, Magurele Town (RO); Takunori Taira, Okazaki-city (JP); Masaki Tsunekane, Okazaki-city (JP)

(72) Inventors: Kenji Kanehara, Toyohashi-city (JP); Nicolaie Pavel, Magurele Town (RO); Takunori Taira, Okazaki-city (JP); Masaki Tsunekane, Okazaki-city (JP)

(73) Assignees: INTER-UNIVERSITY RESEARCH INSTITUTE CORPORATION, NATIONAL INSTITUTES OF NATURAL SCIENCES, Mitaka-city, Tokyo (JP); NIPPON SOKEN, INC., Nishio-city, Aichi-pref. (JP)

(21) Appl. No.: 13/825,467

(22) PCT Filed: Sep. 20, 2011
(86) PCT No.: PCT/JP2011/005268

§ 371 Date: Mar. 21, 2013

(30) Foreign Application Priority Data
Sep. 21, 2010 (JP) 2010-210411
Jan. 25, 2011 (JP) 2011-012645

(51) Int. Cl. F02P 23/04

(52) U.S. Cl. CPC F02P 23/04
USPC 123/143 B

(57) ABSTRACT

A laser ignition system that is mounted on an internal combustion engine and that condenses a laser beam oscillated from a laser oscillator into an engine combustion chamber by using a condenser lens to generate a flame kernel with high energy and to perform ignition includes at least a highly-refractive optical element that refracts optical axes OPX₁ to OPXₙ of plural laser beams oscillated from plural semiconductor lasers 5-1 to 5-n through a resonator to change traveling directions of the laser beams and a condenser device that condenses the laser beams refracted by the highly-refractive optical element on plural positions FP₁ to FPₙ in the engine combustion chamber.

### CROSS-REFERENCE TO RELATED APPLICATIONS

This application is based upon and claims the benefit of priority from Japanese Patent Application No. 2010-210411 filed on Sep. 21, 2010 and Japanese Patent Application No. 2011-12645 field on Jan. 25, 2011, the entire contents of which are incorporated herein by reference.

### TECHNICAL FIELD

The present invention relates to a laser ignition system used for ignition of an internal combustion engine.

### BACKGROUND ART

Recently, from the viewpoint of reducing CO₂ emission, highly-supercharged and highly-compressed vehicle engines which are small-sized and which can achieve high output power and dynamo engines of a cogeneration system which can achieve high efficiency and low NOₓ have been developed. In the highly-supercharged and highly-compressed vehicle engines, the cylinder pressure before ignition is high. Accordingly, when ignition is performed using a sparking plug, it is necessary to increase energy to be supplied to the sparking plug up to several times the conventional energy. In the dynamo engines of a cogeneration system, the cylinder bore diameter is large and the gaseous mixture concentration is low.

In order to cause such engines to combust with high efficiency, an ignition system having a high combustion rate and superior ignition performance is required. As an ignition system which can exhibit superior ignition performance, publication of unexamined Japanese patent application No. 2006-329186 (corresponding to publication of unexamined US patent application No. 2006-0243238) discloses a laser ignition system in which a laser beam is condensed on one point in a combustion chamber to ignite a gaseous mixture. However, even in such a laser ignition system, when the gaseous mixture concentration is lowered, the number of molecules which can absorb a laser beam decreases to degrade ignition performance. When the gaseous mixture concentration in the vicinity of the ignition timing in the combustion chamber has deviation and a laser beam is oscillated in a region in which the gaseous mixture concentration is low, the absorption of the laser beam decreases and a flame spread rate also decreases, thereby not producing good combustion. In an engine having a large bore diameter, even when ignition is successful, the spread of combustion takes much time and the flame may be extinguished without reaching complete explosion.

In view of such a problem, publication of unexamined Japanese patent application No. 2006-161612 discloses a laser ignition system in which a laser beam is applied to a target in a combustion chamber and a gaseous mixture is ignited by the generated plasma therein. The laser ignition system achieves enhancement of ignition performance by combining a half reflecting mirror and a total reflecting mirror to form plural laser beams and applying the plural laser beams to plural targets in the combustion chamber. However, in the laser ignition system disclosed in publication of unexamined Japanese patent application No. 2006-161612, since one laser beam is split by combining plural total reflecting mirrors and half reflecting mirrors and the split laser beams are condensed in the combustion chamber, the split laser beams are condensed on plural condensing points in the combustion chamber simultaneously or almost simultaneously with a very short time difference due to the difference in optical path length, and the ignited combustion starts almost simultaneously from all the condensing points. Accordingly, adjustment of ignition start timings at plural condensing points in the combustion chamber and ignition control corresponding to the gaseous mixture status of the engine are not able to be performed. As shown in FIG. 2 of publication of unexamined Japanese patent application No. 2006-161612, in the configuration where a laser beam having high energy enters a vertex of a polygonally pyramidal beam splitting prism having plural refractive faces, passes through the beam splitting prism, and exits from plural refractive faces, when the entrance position of a laser beam very slightly departs from the vertex of the beam splitting prism, the laser beam is not uniformly split and plural laser beams exiting into the engine combustion chamber are uneven in energy, whereby stable ignition performance may not be secured.

In order to avoid such a problem with the configuration disclosed in publication of unexamined Japanese patent application No. 2006-161612, very high processing precision is required for causing a laser beam to accurately enter the vertex of the beam splitting prism, thereby causing an increase in manufacturing cost. In addition, when a laser beam enters the vertex of the pyramidal beam splitting prism, passes through the beam splitting prism, and exits from plural refractive faces, the laser beam may be scattered in the vicinity of the ridge of the prism to lose about 40% of the input energy and thus the energy necessary for ignition may not be condensed. Accordingly, in order to obtain the energy necessary for ignition, it is necessary to increase the energy of a laser beam, thereby causing an increase in system size, an increase in cost, and a decrease in fuel efficiency. In a polygonally pyramidal shape in which the refractive faces are in odd numbers, since two refractive faces having different angles face the entrance face, the split laser beams may be further split. Accordingly, a desired number of condensing points cannot be obtained or a decrease in energy may be caused due to fine-splitting of a laser beam.

### CITATION LIST

### Patent Literatures

[PTL 1] publication of unexamined Japanese patent application No. 2006-329186

[PTL 2] publication of unexamined Japanese patent application No. 2006-161612 cl SUMMARY OF INVENTION

The present invention is made in consideration of the above-mentioned circumstances and an object thereof is to provide a laser ignition system with a simple configuration which can enhance ignition performance of an internal combustion engine by condensing plural laser beams on desired positions in an engine combustion chamber at arbitrary timing and which can easily achieve a decrease in size and a decrease in cost.

According to a first aspect of the invention, there is provided a laser ignition system that is mounted on an internal combustion engine and that condenses a laser beam oscillated from a laser oscillator into an engine combustion chamber by using a condenser lens to generate a flame kernel with high energy and to perform ignition, including at least: a highly-refractive optical element that refracts optical axes of plural laser beams oscillated from plural semiconductor lasers through a resonator to change traveling directions of the laser beams to directions in which the laser beams get away from a central axis; and a condenser device that condenses the laser beams refracted by the highly-refractive optical element on plural positions in the engine combustion chamber.

According to a second aspect of the invention, there is provided a laser ignition system that is mounted on an internal combustion engine and that condenses a laser beam oscillated from a laser oscillator into an engine combustion chamber by using a condenser lens to generate a flame kernel with high energy and to perform ignition, including at least: a highly-refractive optical element that refracts optical axes of plural laser beams oscillated from plural semiconductor lasers through a resonator to change traveling directions of the laser beams to directions in which the laser beams converge on a predetermined single position; and a condenser device that condenses the plurality of laser beams refracted by the highly-refractive optical element on a single position in the engine combustion chamber.

In a third aspect of the invention, the highly-refractive optical element may be formed of a highly-refractive polyhedron in which a predetermined vertex angle is formed between plural faces on which the plurality of laser beams are incident and a face from which laser beams refracted by a predetermined refraction angle exit.

In a fourth aspect of the invention, the highly-refractive optical element may be a reflective optical element that reflects a laser beam by a high-reflectance reflective film provided on its surface and may be formed of a polyhedron on which the plurality of laser beams are incident at predetermined incidence angles and that totally reflects the plurality of laser beams at the same reflection angles as the incidence angles.

In a fifth aspect of the invention, the laser ignition system may further include: an operating status detection device for detecting an operating status of the internal combustion engine; and a laser oscillation control device that determines a number of oscillations, an oscillating timing, and a number of laser beams in one ignition cycle of the laser beams oscillated from the laser oscillator into the engine combustion chamber based on a detection result of the operating status detection device.

In a sixth aspect of the invention, the laser oscillation control device may control the number of oscillations and the oscillation timing in one ignition cycle based on an application timing and an application time period of electric energy to the semiconductor laser.

In a seventh aspect of the invention, the resonator may include a laser medium, which is excited by the semiconductor laser, and a saturable absorber and may partially change permeability of the saturable absorber.

In an eighth aspect of the invention, a laser beam, which has a short pulse oscillation period and small pulse energy, out of the plurality of laser beams may be arranged in a region having a slow cylinder air flow in the engine combustion chamber of the internal combustion engine.

According to the aspects of the invention, plural laser beams oscillated from the laser oscillator can be changed in the traveling directions by the highly-refractive optical element and can be condensed on plural positions in the engine combustion chamber by the condenser device provided at an end thereof, or plural laser beams oscillated from the laser oscillator can change traveling directions to directions in which the plural laser beams converge on a predetermined position in the engine combustion chamber by the highly-refractive optical element and can be intensively condensed on one position in the engine combustion chamber by the condenser device provided at an end thereof, thereby generating high-energy plasma at plural positions or one position in the engine combustion chamber depending on the combustion characteristics of the engine. Accordingly, the ignition probability can be enhanced to realize stable combustion.

By adjusting the refractive index and the vertex angle of the highly-refractive optical element, the beam diameter, the spread angle, and the wavelength of the laser beam oscillated from the laser oscillator, and the distance between the condenser device and the condensing point, a desired condensing position and a desired condensing intensity can be arbitrarily set.

The control can also be performed by providing a time difference to the condensing timing of condensing laser beams oscillated from plural semiconductor lasers.

### BRIEF DESCRIPTION OF DRAWINGS

The above-mentioned or other objects, configurations, and advantages of the invention will be apparent from the following detailed description with reference to the accompanying drawings.

FIG. 1 is a cross-sectional view schematically illustrating a laser ignition system according to a first embodiment of the invention.

FIG. 2 is a diagram illustrating the principles of the laser ignition system according to the first embodiment.

FIGS. 3A to 3E are plan views, cross-sectional views, and bottom views of beam expanders corresponding to condensation on two or six points and show modified examples of a beam expander of the laser ignition system according to the first embodiment.

FIGS. 4A to 4E are plan views, cross-sectional views, and bottom views of highly-refractive optical elements corresponding to two to six condensing points and show modified examples of a highly-refractive optical element of the laser ignition system according to the first embodiment.

FIGS. 5A to 5C are plan views, cross-sectional views, and bottom views of condenser lenses corresponding to two condensing points and show modified examples of a condenser lens of the laser ignition system according to the first embodiment.

FIGS. 6A to 6D are plan views, cross-sectional views, and bottom views of condenser lenses corresponding to three to six condensing points and show other modified examples of the condenser lens of the laser ignition system according to the first embodiment.

FIG. 7 is a cross-sectional view schematically illustrating the laser ignition system according to the first embodiment when six condensing points are provided.

FIG. 8 is a cross-sectional view schematically illustrating a laser ignition system according to a second embodiment of the invention.

FIGS. 9A and 9B are a cross-sectional view of a principal part and a cross-sectional view of a highly-refractive optical element, respectively, in a laser ignition system according to a third embodiment of the invention.

FIG. 10 is a cross-sectional view schematically illustrating a laser ignition system according to a fourth embodiment of the invention.

FIG. 11 is a cross-sectional view of a principal part illustrating a laser ignition system according to a fifth embodiment of the invention.

FIG. 12 is a cross-sectional view schematically illustrating a laser ignition system according to a sixth embodiment of the invention.

FIG. 13 is a timing diagram illustrating an example of a method of controlling a laser ignition system according to a seventh embodiment of the invention.

FIGS. 14A to 14D are diagrams schematically illustrating a flame spread effect when the laser ignition system according to the seventh embodiment is used.

FIGS. 15A to 15C are schematic diagrams of a principal part illustrating a laser ignition system according to an eighth embodiment and a modified example thereof.

FIGS. 16A to 16C are schematic diagrams of a principal part illustrating a laser ignition system according to the eighth embodiment and another modified example thereof.

FIG. 17 is a cross-sectional view schematically illustrating the laser ignition system according to the eighth embodiment.

FIG. 18 is a timing diagram illustrating an example of a method of controlling the laser ignition system according to the eighth embodiment.

FIGS. 19A to 19D are diagrams schematically illustrating a flame growth effect in the laser ignition system according to the eighth embodiment.

FIGS. 20A and 20B are a cross-sectional view of a principal part and a cross-sectional view of a highly-refractive optical element, respectively, in a laser ignition system according to a ninth embodiment.

FIGS. 21A and 21B are cross-sectional views illustrating modified examples of a beam expander and a highly-refractive optical element of the laser ignition system according to the ninth embodiment.

FIGS. 22A and 22B are a cross-sectional view of a principal part and a cross-sectional view of a highly-refractive optical element, respectively, in a laser ignition system according to a tenth embodiment.

FIGS. 23A and 23B are cross-sectional views illustrating modified examples of a beam expander and a highly-refractive optical element of the laser ignition system according to the tenth embodiment.

### DESCRIPTION OF EMBODIMENTS

### First Embodiment

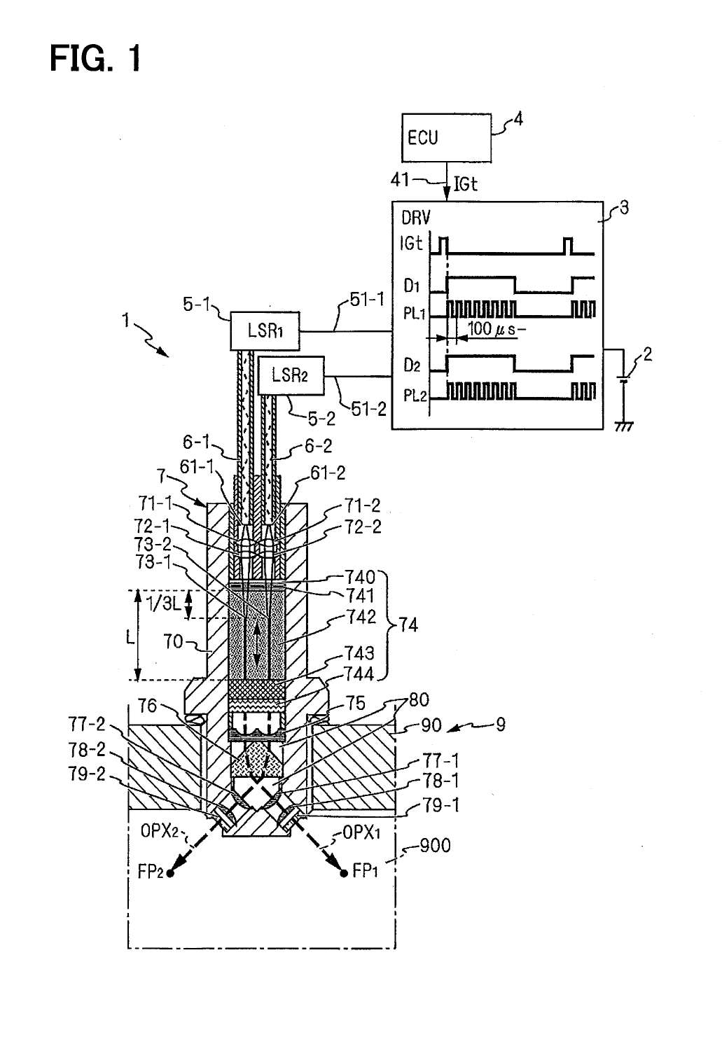

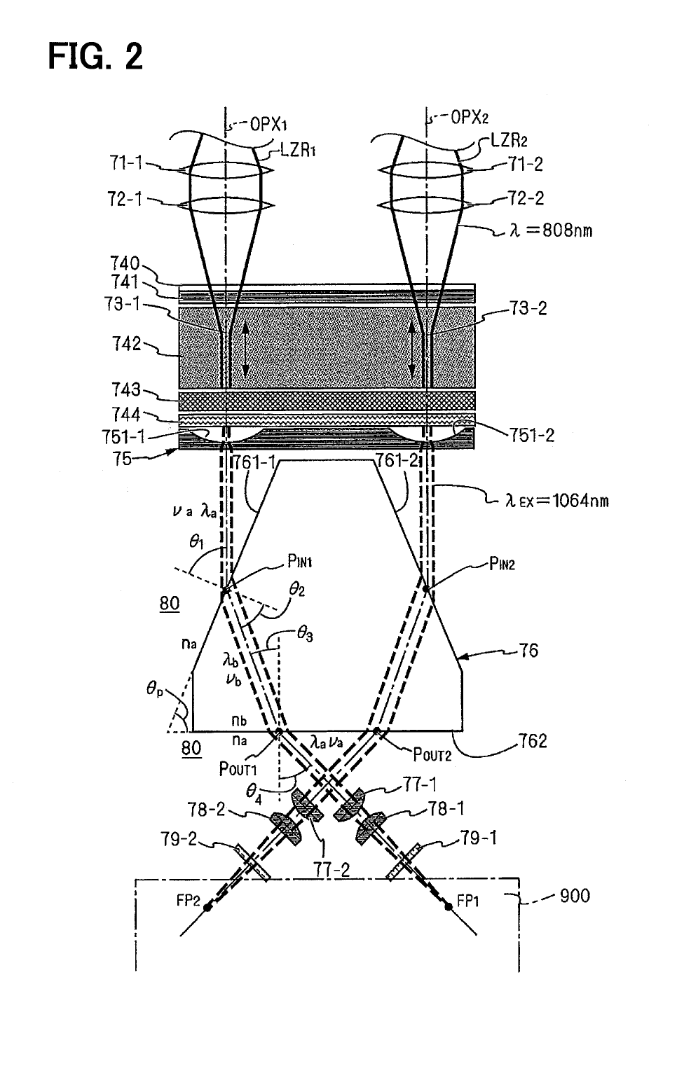

The configuration and operation of a laser ignition system 1 according to a first embodiment of the invention will be described with reference to FIGS. 1 and 2. The laser ignition system 1 according to the first embodiment is an ignition system that is mounted on a cylinder head 90 of an internal combustion engine 9 not drawn and that greatly refracting optical axes OPX₁ and OPX₂ of plural laser beams by using a highly-refractive optical element 76, condenses the laser beams on plural condensing points FP₁ and FP₂ in an engine combustion chamber 900, generates flame kernels at plural positions in the engine combustion chamber 900 to ignite a gaseous mixture. Particularly, use for ignition of an ignition-retardant highly-supercharged engine, a highly-compressed engine, a thin gaseous mixture engine, and the like is assumed.

The laser ignition system 1 includes a power source 2, a semiconductor laser driving circuit (DRV) 3, an engine ECU 4, plural semiconductor lasers 5-1 and 5-2, optical fibers 6-1 and 6-2 that transmit excitation laser beams oscillated from the semiconductor lasers 5-1 and 5-2, and a laser ignition plug 7 that is mounted on the cylinder head 90 of the engine 9. The laser ignition plug 7 constitutes a laser oscillator that oscillates a laser beam as a predetermined pulse, and includes collimator lenses 71-1 and 71-2 that adjust the excitation laser beams transmitted through the optical fibers 6-1 and 6-2 to parallel beams, condenser lenses 72-1 and 72-2 that condense the excitation laser beams adjusted by the collimator lenses, a resonator 74 that resonates the excitation laser beams condensed by the condenser lenses 72-1 and 72-2 and oscillates pulse laser beams, a beam expander 75 that enlarges the beam diameter of the pulse laser beams oscillated from the resonator 74, a highly-refractive optical element 76 as a principal part that refracts the traveling directions of the pulse laser beams, condenser lenses 77-1, 77-2, 78- 1, and 78-2 that are provided as a condenser device for condensing the laser beams refracted by the highly-refractive optical elements 76 on condensing points FP₁ and FP₂ in the engine combustion chamber 900, and protective covers 79-1 and 79-2 that protect the condenser lenses 77-1, 77-2, 78-1, and 78-2 from pressure, high heat, and attachment of fuel in the engine combustion chamber 900. The resonator 74 includes a total reflecting mirror 741, a laser medium 742, a saturable absorber 743, and a partial reflecting mirror 744 which are provided in a chassis 70.

The ECU 4 sends out an ignition signal IGt to the DRV 3 through a signal line 41 depending on the operating status of the engine 9. The DRV 3 generates drive signals D₁ and D₂ for driving the semiconductor lasers 5-1 and 5-2 on the basis of the ignition signal IGt sent from the ECU 4, controls an application timing and an application time period of current to be applied to the semiconductor lasers 5-1 and 5-2 through semiconductor laser driving lines 51-1 and 51-2 from the power source 2 to control the energy intensity and the oscillation timing of the excitation laser beams emitted from the semiconductor lasers 5-1 and 5- 2.

The excitation laser beams emitted from the semiconductor lasers 5-1 and 5-2 are transmitted to the laser ignition plug 7 mounted on the cylinder head 90 through the optical fibers 6-1 and 6- 2. The excitation laser beams emitted from the end faces 61-1 and 61-2 of the optical fibers 6-1 and 6-2 are adjusted to parallel beams by the collimator lenses 71-1 and 71- 2, are reduced in beam diameter by the condenser lenses 72-1 and 72- 2, are condensed on condensing points 73-1 and 73-2 located within about ⅓ to ½ of the distance from the end face of the resonator 74 to the laser medium 742 via a film 740 which is formed on the incidence face of the resonator 74 to prevent reflection of an excitation beam, and are incident on the resonator 74 so as to be parallel beams straightly traveling in the laser medium 742.

The excitation laser beams (for example, 808.5 nm) incident on the resonator 74 causes the laser medium 742 to emit fluorescent light and to inductively emit light of a long wavelength (for example, 1064 nm). The light of a wavelength longer than the excitation laser beams and generated in the laser medium is resonated in the total reflecting mirror 741 that allows incidence of the excitation laser beams from the incidence face of the resonator 74 and that totally reflects the light of a wavelength longer than that of the excitation laser beams and generated in the laser medium, the laser medium 742, the saturable absorber 743, and the partial reflecting mirror 744, and is amplified until going over a threshold value unique to the saturable absorber 743. When the resonated and amplified laser beam goes over the threshold value, the saturable absorber 743 operates as a passive Q-switch and a laser beam having a high energy density is instantaneously emitted. In this embodiment, when energy of 23 mJ is supplied as the excitation energy, the laser beam oscillated from the resonator 74 has capability of oscillating a parallel beam with a beam diameter of 1.2 mm, a pulse width of 1 ns, and energy of 3 mJ. In order to raise the energy density at the condensing points FP₁ and FP₂ in the combustion chamber 900, the beam diameter of the laser beam oscillated from the resonator 74 is enlarged by using the beam expander 75 including a plano-concave lens.

Concave face portions 751-1 and 751-2 of which the central axes are matched with the optical axes OPX₁ and OPX₂ are formed in the beam expander 75 to correspond to the number of laser beams oscillated from the resonator 74. The plural laser beams passing through the beam expander 75 enter entrance faces 761-1 and 761-2 provided in the highly-refractive optical element 76, which is a principal part, at a predetermined incidence angle θ₁ (for example, 45°).

In this embodiment, the highly-refractive optical element 76 is formed of, for example, a highly-refractive material selected from quartz, synthetic quartz, and borosilicate glass and is formed in a triangular prism shape. The vertex angle θₚ of a polyhedral prism which is formed between two entrance faces 761-1 and 761-2 which plural laser beams enter and an exit face 762 in which a laser beam is refracted at an interface between the highly-refractive optical element 76 and an air layer 80 to change its traveling direction and from which emit the laser beam at a predetermined refraction angle θ₄ is formed as a predetermined angle such as 45°. The exit face 762 forms a plane perpendicular to the central axis of the laser ignition plug 7. The plural laser beams passing through the concave face portions 751-1 and 751-2 of the beam expander 75 enter the entrance faces 761-1 and 762-2 of the highly-refractive optical element 76 at the incidence angle θ₁ (=θₚ, for example, 45°) about the normal lines of the entrance faces, respectively, and exit from the exit face 762 of the highly-refractive optical element 76 at the refraction angle θ₄ (for example, 45°).

The laser beams emitted from the exit face 762 are condensed on the condensing points FP_{1 and FP}₂ at predetermined positions in the engine combustion chamber 900 by the condenser lenses 77-1, 77-2, 78-1, and 78-2 to generate high-energy plasma and the gaseous mixture is ignited at plural positions in the engine combustion chamber 900. At this time, the positions and the condensing intensities of the condensing points FP₁ and FP₂ are calculated by the curvatures of the concave face portions 751-1 and 751-2 of the beam expander 75, the curvatures of the condenser lenses 77-1, 77-2, 78-1, and 78-2, the distances between the beam expander 75 and the condenser lenses 77-1, 77-2, 78-1, and 78-2, the laser quality (M²), the vertex angle θₚ of the highly-refractive optical element 76, the absolute refractive index nₐ of air, the absolute refractive index n_{b} of the highly-refractive optical element 76, the wavelength λₐ of a laser beam when passing through an air layer, and the wavelength λ_{b} of a laser beam when passing through the highly-refractive optical element 76, and a desired position and a desired condensing intensity can be arbitrarily set. The condenser lenses 77-1, 77-2, 78-1, and 78-2 adjust a spherical aberration, a comatic aberration, and an astigmatism by combining two or three lenses. The condenser lenses 77-1, 77-2, 78-1, and 78-2 may be any one of a spherical lens and an aspheric lens.

The entrance faces 761-1 and 761-2 and the exit face 762 of the highly-refractive optical element 76 face an air layer 80, and the incidence angle θ₁ on the entrance faces 761-1 and 761-2 of the highly-refractive optical element 76 from the air layer 80, the refraction angle θ₂ when a laser beam travels in the highly-refractive optical element 76, the incidence angle θ₃ on the exit face 762 of the highly-refractive optical element 76, the refraction angel θ₄ when a laser beam exits from the highly-refractive optical element 76, the absolute refractive index nₐ of the air layer 80, the absolute refractive index n_{b} of the highly-refractive optical element 76, the relative refractive index n_{ab} when a laser beam enters the highly-refractive optical element 76 from the air layer 80, the relative refractive index n_{ba} when a laser beam exits from the highly-refractive optical element 76 to the air layer 80, the wavelength λₐ of a laser beam when passing through the air layer, and the wavelength λ_{b} of a laser beam when passing through the highly-refractive optical element 76 have the following relationship.

$$\begin{matrix}{θ}_{1} = {θ}_{p} & Expression 1 \\ \frac{sin {θ}_{1}}{sin {θ}_{2}} = \frac{{n}_{b}}{{n}_{a}} = {n}_{ab} = \frac{{λ}_{a}}{{λ}_{b}} & Expression 2 \\ \frac{sin {θ}_{3}}{sin {θ}_{4}} = \frac{{n}_{a}}{{n}_{b}} = {n}_{ba} = \frac{{λ}_{b}}{{λ}_{a}} = \frac{sin {θ}_{2}}{sin {θ}_{1}} & Expression 3\end{matrix}$$

In this embodiment, the optical axes OPX₁ and OPX₂ of the laser beams oscillated from the plural semiconductor lasers 5-1 and 5-2 and amplified by the resonator 74 are greatly refracted by the use of the highly-refractive optical element 76, and the laser beams are condensed into the combustion chamber 900 by the use of the condenser lenses 77-1, 77-2, 78-1, and 78-2. Accordingly, the distance between the condensing points FP₁ and FP₂ can be increased and the ignition probability can be raised by simultaneously starting the ignition at plural positions in the internal combustion engine 9 having a large bore diameter.

When laser beams of high energy levels are condensed on plural positions in the engine combustion chamber 900, plasma is generated at the condensing points FP₁ and FP₂. Accordingly, the combustion rate increases and the gaseous mixture in the engine combustion chamber 900 can be early ignited. By maintaining the supply of current to the semiconductor lasers 5-1 and 5-2 using the drive signals D₁ and D₂ generated in the DRV 3 in response to the ignition signal IGt, the pulse laser beams PL₁ and PL₂ oscillated from the laser ignition plug 7 and condensed into the engine combustion chamber 900 can be repeatedly condensed at intervals of 100 μs to 130 μs and the growth of flame kernels can be promoted by repeatedly inputting energy to the gaseous mixture, thereby achieving enhancement in combustion rate.

The laser beams can be simultaneously condensed on the condensing points FP₁ and FP₂ in response to one ignition signal IGt oscillated from the ECU 4, or a time difference may be provided to the current application timing to the semiconductor lasers 5-1 and 5-2 and the laser beams may be sequentially condensed on the plural condensing points FP₁ and FP₂. By performing such control having a time difference, a time difference can be provided to the growth of flame kernels generated at the condensing points FP₁ and FP₂ to generate a flow in the gaseous mixture. Accordingly, the responsiveness can be enhanced to further enhance the combustion rate or to suppress a knocking phenomenon.

By changing characteristics of the excitation and condensing portions of the plural semiconductor lasers as well as adjusting the current application timing, the oscillation timing of a laser beam may be changed. In this aspect, instead of providing plural laser ignition plugs in the engine combustion chamber for forming plural condensing points, plural laser beams oscillated from a single laser ignition plug 7 are greatly refracted by using the highly-refractive optical element 76 and are condensed on plural positions in the engine combustion chamber 900, thereby easily reducing the system size.

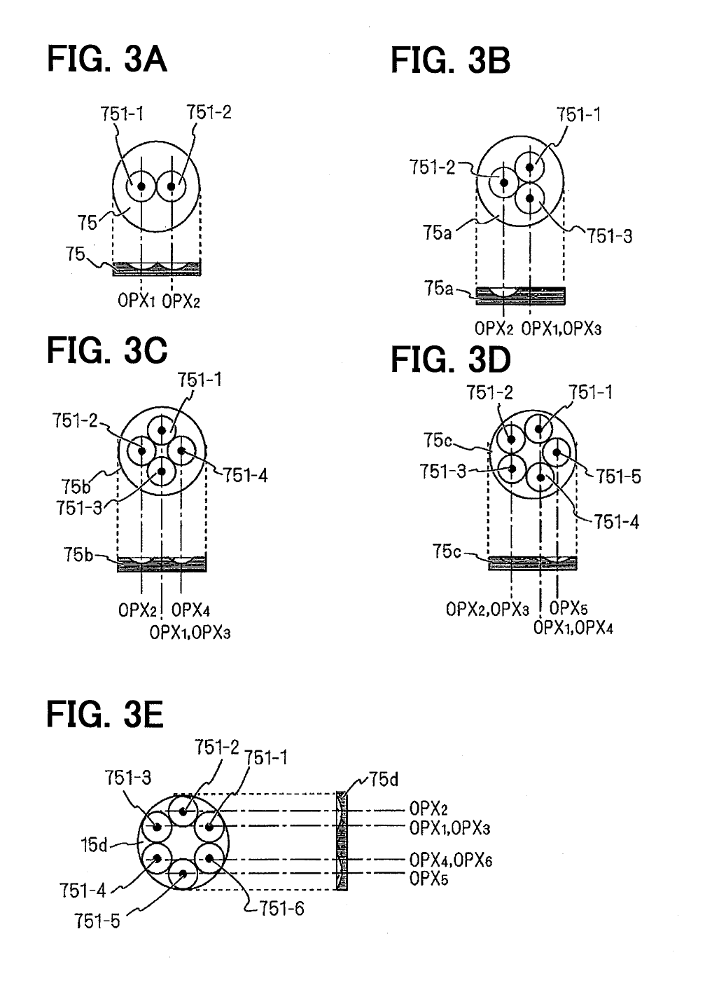

It is mentioned in the above-mentioned embodiment that two condensing points FP₁ and FP₂ are formed, but the number of condensing points can be easily increased in this aspect and several modified examples thereof will be described below. The same elements as in the above-mentioned embodiment will be referenced by the same reference numerals, description thereof will not be repeated, and differences will be mainly described. Modified examples of the constituents when the condensing points FP₁ to FPₙ are formed at plural positions in the engine combustion chamber 900 with a simple configuration will be described with reference to FIGS. 3A to 6D.

FIGS. 3A to 3E show examples of beam expanders 75, 75a, 75b, 75c, and 75d corresponding to two to six condensing points FP. In this embodiment, the beam expanders 75, 75a, 75b, 75c, and 75d have concave face portions 751-1 to 751-6 formed in a substantially-columnar base to correspond to the number of condensing points FP₁ to FPₙ and the outer diameter is the same as that in the case where two condensing points are formed. The number of condensing points FP can be increased without changing the physical size.

In order to enhance the amounts of the laser beams incident on the concave face portions 751-1 to 751- 6 of the beam expanders 75, 75a, 75b, 75c, and 75d, it is necessary to bind the optical fibers 5-1 to 5-6 corresponding to the number of laser beams and connect the optical fibers to the resonator 74. However, since the excitation laser beams are transmitted in the optical fibers 5-1 to 5-6 while being totally reflected, the plural excitation laser beams do not interfere with each other.

When the plural excitation laser beams are transmitted to the resonator 74, the straightness of the laser beams is high and thus the laser beams are not affected by each other.

The laser oscillation timing can be controlled on the basis of the oscillation timing of the excitation semiconductor lasers and the permeability of the Q-switch. For example, when the permeability of the Q-switch is constant, the laser beams are parallel in a crystal. Accordingly, when the laser beams are separated from each other by about 1 mm, the neighboring laser beams do not interfere with each other. The laser oscillation timing can be controlled on the basis of the oscillation timing of the excitation semiconductor lasers.

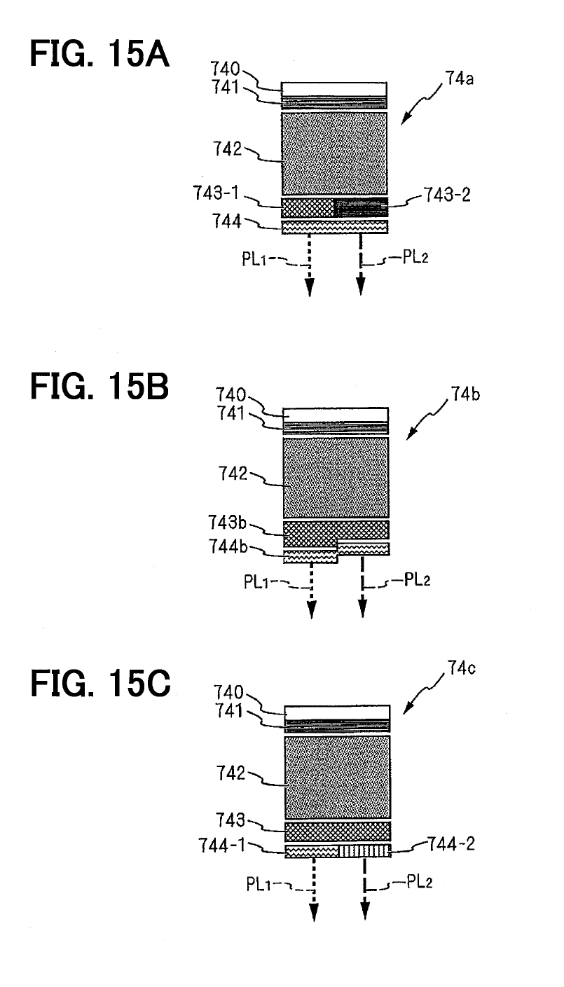

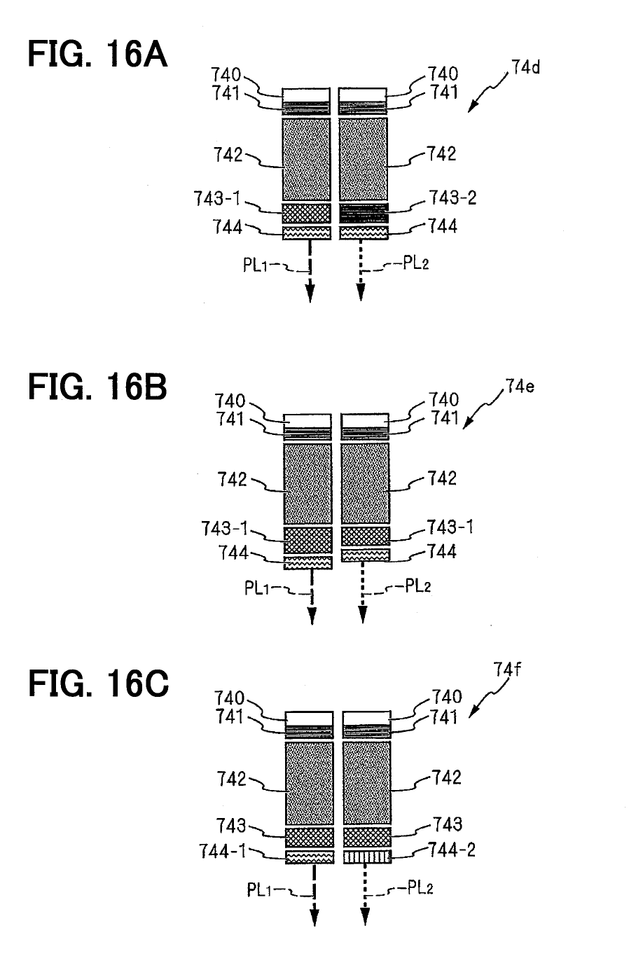

When the permeability of the Q-switch corresponding to each laser is changed, the thickness or the Cr concentration should be changed to change the permeability of the saturable absorber 742 and it is thus preferable to partition the resonator 74. In this case, by changing the oscillation timing of the excitation semiconductor lasers, the degree of control freedom of the laser oscillation timing can be further enhanced in comparison with the case where the permeability of the Q-switch is kept constant. More specific configurational examples will be described later with reference to FIGS. 15A to 16C.

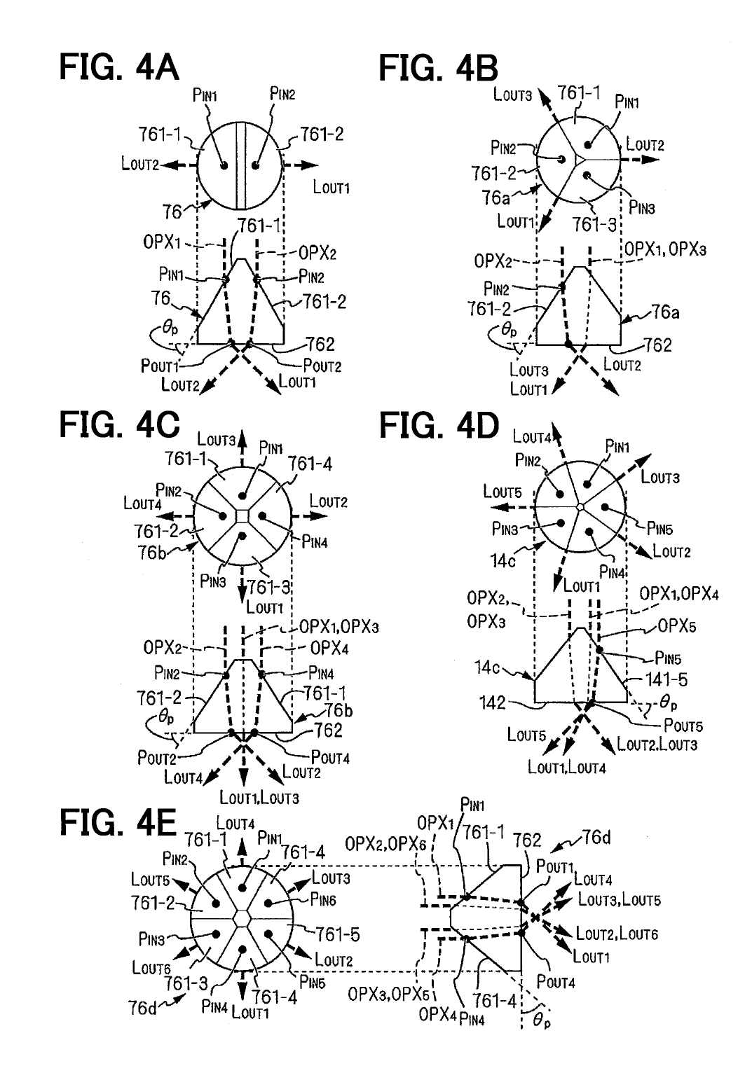

FIGS. 4A to 4E show configurational examples of the highly-refractive optical elements 76, 76a, 76b, 76c, and 76d as a principal part corresponding to two to six condensing points FP. By forming the entrance faces 761-1 to 762-2 using a regularly polygonal pyramid under the condition that the vertex angle θₚ formed by the entrance faces 761-1 to 761-6 and the exit face 762 is fixed, the entrance faces 761-1 to 761-6 can be formed by a necessary number. In this embodiment, the exit faces 762 of the highly-refractive optical elements 76, 76a, 76b, 76c, and 76d are formed of a plane perpendicular to the incidence direction of a laser beam, that is, the central axis in the length direction of the laser ignition plug 7. In the drawings, points P_{IN1} to P_{IN6} represent the positions of the optical axes of the laser beams entering the entrance faces 761-1 to 761-6, and points P_{OUT1} to P_{OUT6} represent the exit positions on the exit faces 762. The optical axes OPX₁ to OPX₆ representing the refraction directions of the laser beams in the embodiments are indicated by bold dotted lines.

When the laser beams expanded by using the concave face portions 751-1 to 751-6 of the beam expanders 75, 75a, 75b, 75c, and 75d shown in FIGS. 3A to 3E enter the entrance faces 761-1 to 761-6 of the corresponding highly-refractive optical elements 76, 76a, 76b, 76c, and 76d shown in FIGS. 4A to 4E, the laser beams can be made to exit from the exit face 762 with the optical axes OPX₁ to OPX₆ greatly refracted. As shown in the plan views of FIGS. 4A to 4E, the outer peripheral surface has a circular shape in this embodiment, but the shape of the side surface of the highly-refractive optical elements 76, 76a, 76b, 76c, and 76d is not limited to the circular shape and may be polygonal. Whether to set the side surface to a circular shape or a polygonal shape can be properly selected in consideration of workability, assemblability, and the like.

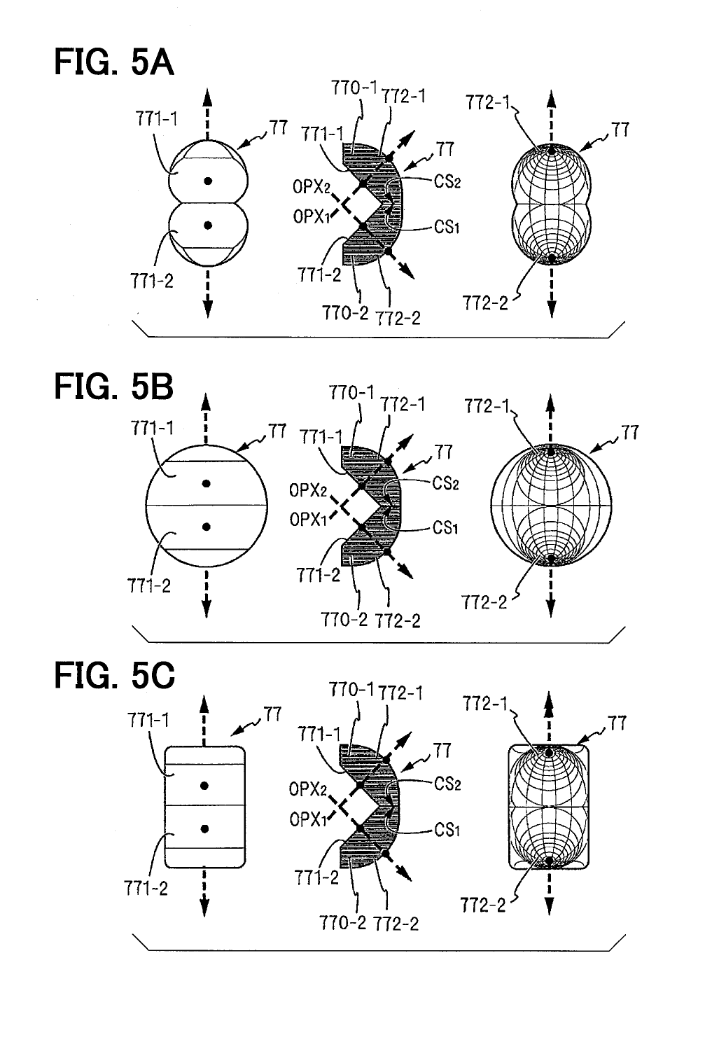

Modified examples of the condenser lenses of the laser ignition system according to the first embodiment will be described with reference to FIGS. 5A to 5C. FIGS. 5A to 5C show plan views, cross-sectional views, and bottom views of the condenser lenses 77-1 and 77-2 corresponding to two condensing points. By forming cut faces CS₁ and CS₂ in two condenser lenses 77-1 and 77-2 by cutting parts of the condenser lenses at a predetermined angle and causing the cut faces to oppose each other as shown in FIG. 5A, the central axes of the condenser lenses 77-1 and 77-2 can be provided to match the optical axes OPX₁ and OPX₂ refracted through the highly-refractive optical element 76. The outer peripheral surface may be formed in a circular shape depending on the shape of the chassis 70 as shown in FIG. 5B, or may be formed in a rectangular shape as shown in FIG. 5C. One or two condenser lenses 78-1 and 78-2 are provided with the optical axes matched with the condenser lenses 77-1 and 77-2 and the curvatures of the exit faces 772-1 ad 772-2 are adjusted to condense the laser beams on desired positions in the engine combustion chamber 900.

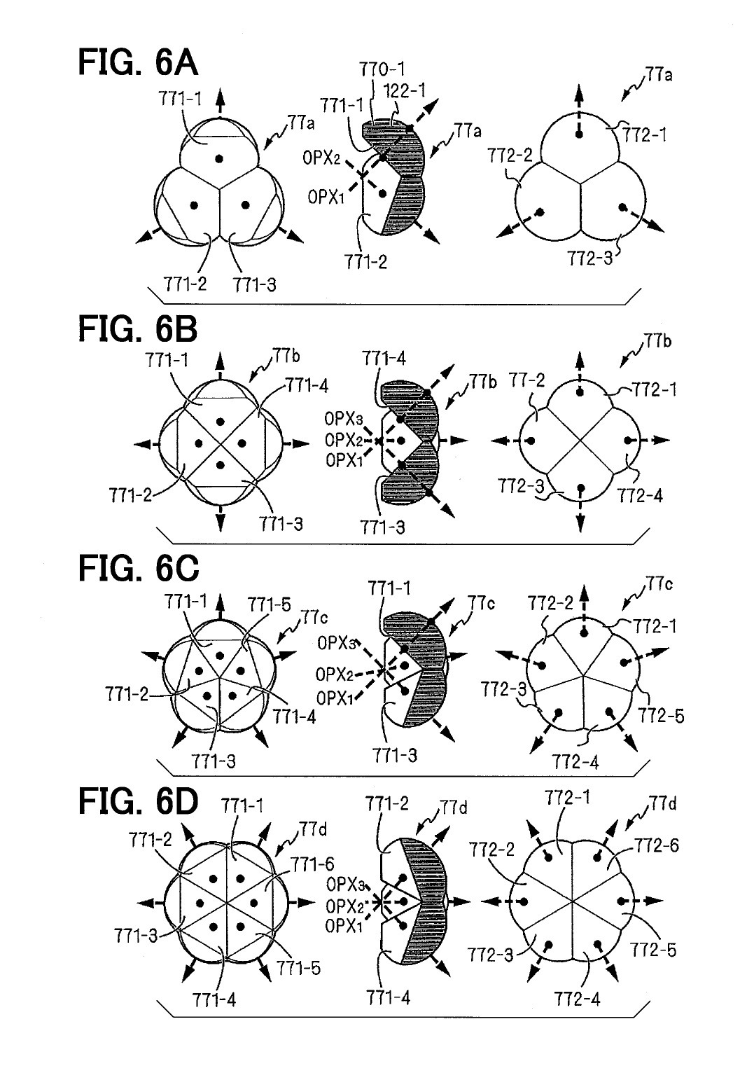

Other modified examples of the condenser lenses of the laser ignition system according to the first embodiment will be described below with reference to FIGS. 6A to 6D. FIGS. 6A to 6D show plan views, cross-sectional views, and bottom views of the condenser lens corresponding to three to six condensing points. As described above, when plural entrance faces 761-1 to 761-n are formed in the highly-refractive optical element 76 and plural laser beams are refracted and output in an arbitrary direction, the central axes of the condenser lenses 771-1 to 771-n can be easily matched with the optical axes OPX₁ to OPXₙ of the laser beams without increasing the physical size of the laser ignition plug 7, by arranging the condenser lenses 771-1 to 771-n in a petal-like shape as shown in FIGS. 6A to 6D.

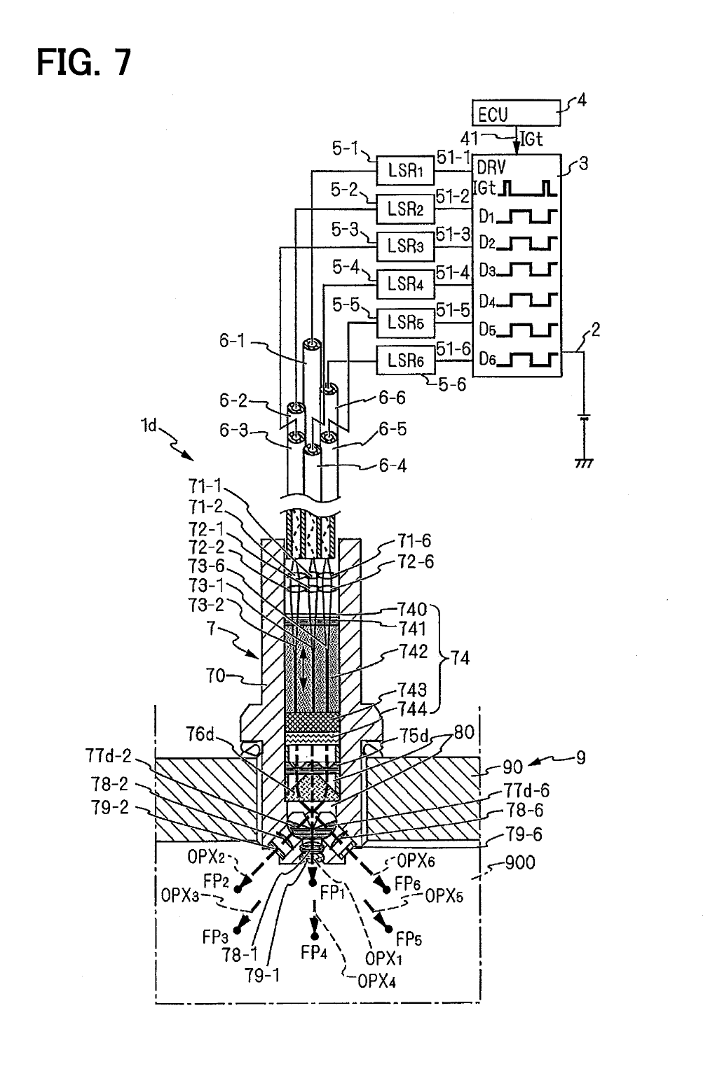

The entire configuration and the operation of a laser ignition system 1d capable of forming six condensing points FP₁ to FP₆ in the first embodiment will be described below with reference to FIG. 7. In this embodiment, the DRV 3 forms drive signals D₁ to D₆ for oscillating laser beams to be condensed on six condensing points FP₁ to FP₆ on the basis of the ignition signal IGt sent from the ECU 4.

A predetermined amount of energy is supplied to the semiconductor lasers 5-1 to 5- 6 in response to the drive signals D₁ to D₆, excitation laser beams are oscillated from the semiconductor lasers 5-1 to 5- 6 and are supplied to the laser ignition plug 7 through the optical fibers 6-1 to 6-6. The optical fibers 6-1 to 6-6 may be formed as a unified coaxial cable. The excitation laser beams transmitted while being totally reflected in the optical fibers 6-1 to 6-6 are condensed on the condensing points 73-1 to 73-6 by the collimator lenses 71-1 to 71-6 and 72-1 to 72-6 and are resonated in the resonator 74 including the total reflecting mirror 741, the laser medium 742, the saturable absorber 743, and the partial reflecting mirror 744. The laser medium 742 is excited by the excitation laser beams and is amplified up to greater than the threshold value unique to the saturable absorber 743. When reaching greater than the threshold value, the saturable absorber 743 serves as a passive Q-switch and six pulse laser beams instantaneously having a high energy density are oscillated.

The pulse laser beams oscillated from the resonator 74 are enlarged in diameter by the beam expander 75d having six concave face portions 751-1 to 751-6, enter the polygonally pyramidal highly-refractive optical element 76d having six entrance faces 761-1 to 761-6, are greatly refracted in the optical axes OPX₁ to OPX₆, and exit in six directions from the exit face 762. The six laser beams exiting from the highly-refractive optical element 76d are condensed on plural condensing points FP₁ to FP₆ in the engine combustion chamber 900 by the condenser lens 77d and the condenser lenses 78-1 to 78-6 and generate plasma at plural positions to ignite the gaseous mixture in the engine combustion chamber 900.

### Second Embodiment

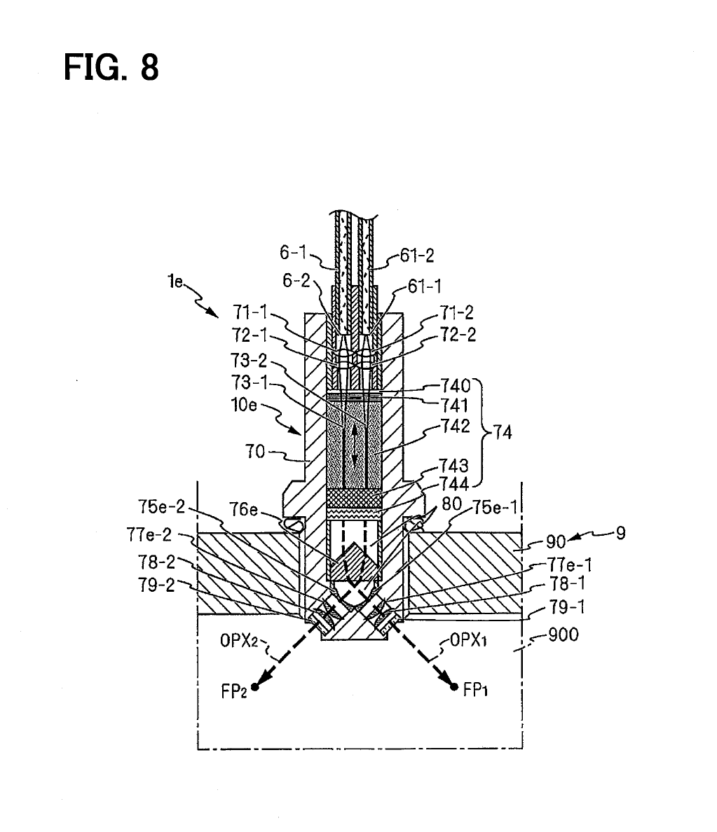

A laser ignition system le according to a second embodiment of the invention will be schematically described with reference to FIG. 8. The configuration in which the laser beams exiting from the resonator 74 are expanded by the beam expander 75 and are refracted by the highly-refractive optical element 76 is described in the above-mentioned embodiment, but a configuration in which laser beams exiting from the resonator 74 are refracted by a highly-refractive optical element 76e, are then expanded once by beam expanders 75e-1 and 75e-2, and are additionally condensed by condenser lenses 77e-1, 77e-2, 78-1 and 78-2 may be employed as shown in FIG. 8. At this time, parts of the beam expanders 75e-1 and 75e-2 may be cut to form a petal-like shape and may be intensively unified, like the condenser lenses 77-1 and 77-2 shown in FIGS. 5A to 5C and FIGS. 6A to 6D.

The condenser lenses 77e-1 and 77e-2 in this embodiment are not unified unlike the above-mentioned embodiment, but are independently provided. In this embodiment, the number of condensing points FP₁ to FPₙ can be arbitrarily set by forming the entrance faces 761-1 to 761-n of the highly-refractive optical element 76 in a polygonally pyramidal shape and providing the concave face portions 751-1 to 75-n of the beam expanders 75e-1 to 75e-n and the condenser lenses 77-1 to 77-n and 78-1 to 78-n to correspond to the number of laser beams entering the entrance faces 761-1 to 761-n.

### Third Embodiment

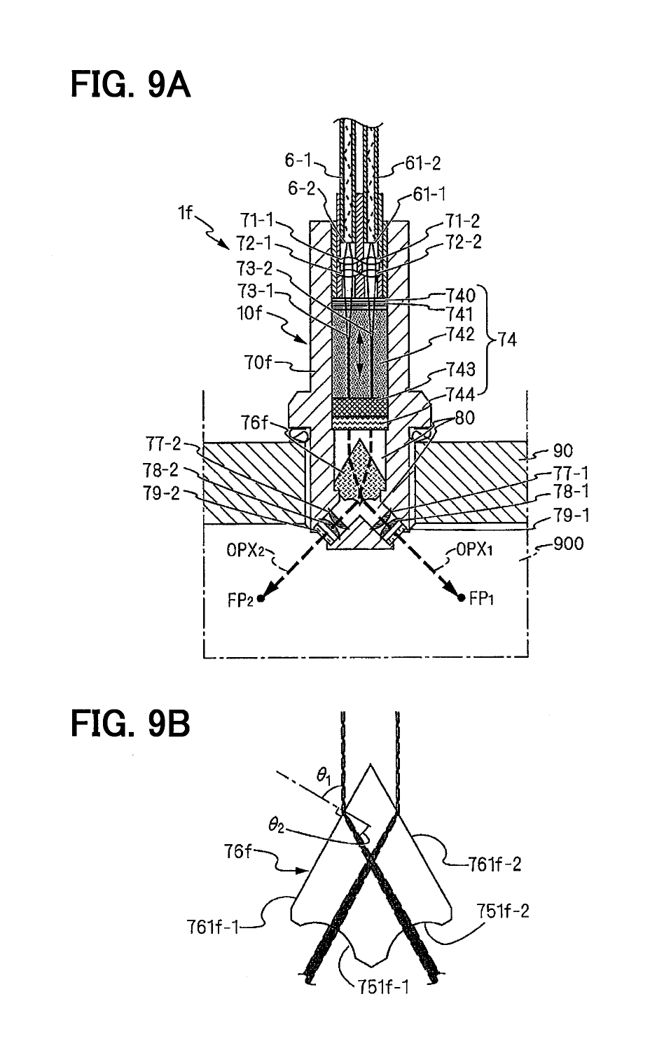

A laser ignition system according to a third embodiment of the invention will be schematically described with reference to FIGS. 9A and 9B. The configuration in which the beam expander 75 and the highly-refractive optical element 76 are separately formed is described in the above-mentioned embodiment, but this embodiment is different from the above-mentioned embodiment in that, as a highly-refractive optical element 76f, concave face portions 751f- 1751f-2 are formed on the exit face of the highly-refractive optical element 76f as shown in FIG. 9B, and a part of the highly-refractive optical element 76f also serves as the beam expander 75. The optical axes OPX₁ and OPX₂ of the laser beams entering the entrance faces 761f-1 and 761f-2 at an incidence angle θ₁ are refracted by a refraction angle θ₂ and the laser beams are expanded when exiting from the concave face portions 751f-1 and 751f- 2. The same advantages as in the above-mentioned embodiment are achieved in this embodiment.

### Fourth Embodiment

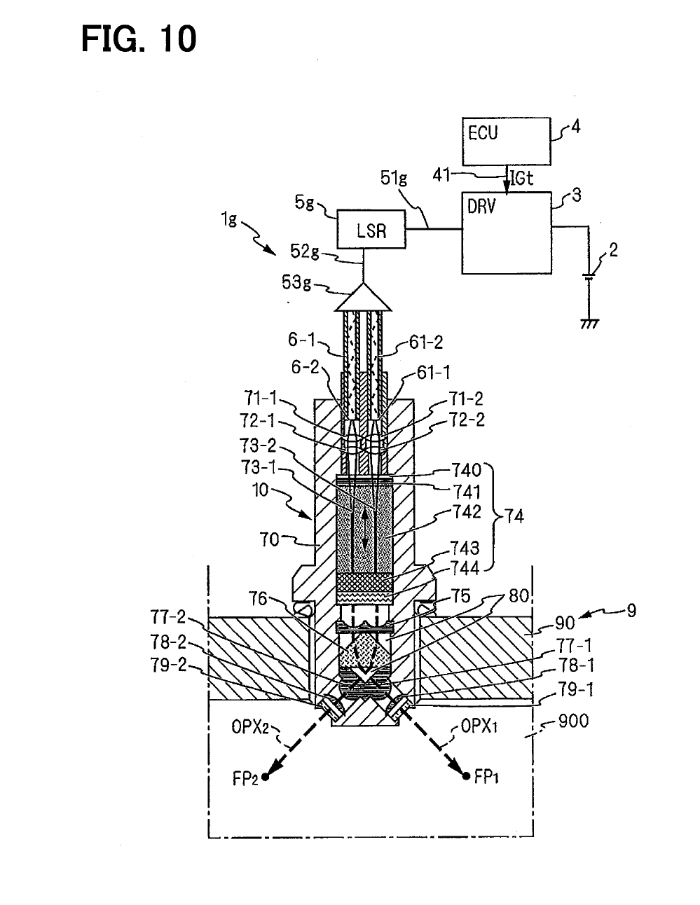

A laser ignition system 1g according to a fourth embodiment of the invention will be schematically described with reference to FIG. 10. The configuration in which the semiconductor lasers 5-1 to 5-n corresponding to the number of laser beams are provided to output the plural laser beams is described in the above-mentioned embodiment, but this embodiment is different from the above-mentioned embodiment, in that an excitation laser beam oscillated from a single semiconductor laser 5g is split by a splitter device 53g and the split laser beams are transmitted to the laser ignition plug 7. The splitter device 53g may split the excitation laser beam output from the semiconductor laser 5g, for example, by the use of a half reflecting mirror and may cause the split laser beams to enter the optical fibers 6-1 and 6-2.

By employing this configuration, since the number of semiconductor lasers 5g can be reduced to a half of the number of laser beams to be output, the physical size thereof can be further reduced. Since the energy of the laser beams output from the laser ignition plug 7 is reduced to a half, it is necessary to double the energy supplied from the DRV 3 to the semiconductor laser 5g. A configuration in which plural splitter device are provided and the laser beam output from the single semiconductor laser 5g is divided into plural laser beams may be employed, thereby increasing the number of condensing points.

### Fifth Embodiment

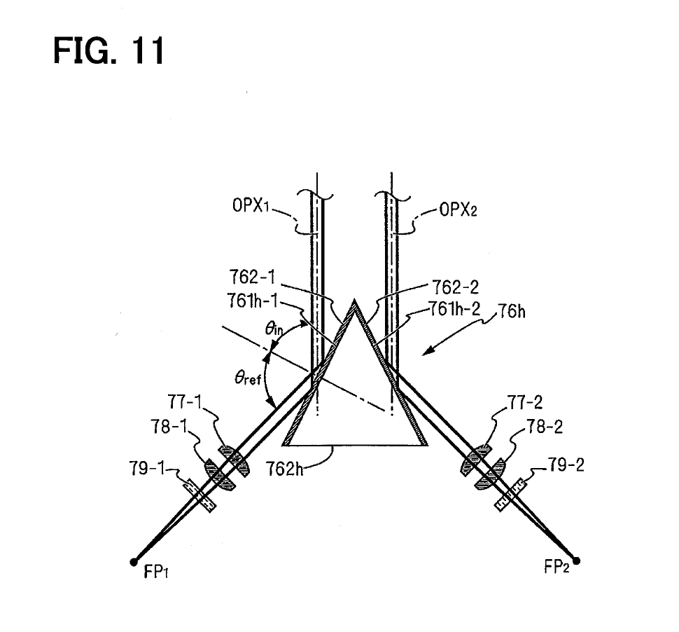

A laser ignition system according to a fifth embodiment of the invention will be schematically described with reference to FIG. 11. The configuration in which the transmissive prism refracting the optical axes of the laser beams by causing the laser beams to pass through an optical element having a high refractive index is used as the highly-refractive optical element is described in the above-mentioned embodiment, but this embodiment is different from the above-mentioned embodiment, in that a reflective optical element 76h which is a polyhedral reflecting mirror refracting the optical axes of the laser beams by totally reflecting the laser beams without causing the laser beams to pass the optical element is used as the highly-refractive optical element. As shown in the drawing, in the reflective optical element 76h, the laser beams incident on the entrance faces 761-h-1 and 761h-2 at an incidence angle θᵢₙ are totally reflected at the same reflection angle θ_{ref} as the incidence angle θᵢₙ, are condensed on the plural condensing points FP₁ and FP₂ in the engine combustion chamber by the condenser lenses 77-1, 77-2, 78-1 and 78-2, thereby igniting the gaseous mixture at separated positions in the engine combustion chamber.

Since a reflective film formed of a high-reflectance material is formed on the surface of a base in which the reflective optical element 76h is formed in a polygonally pyramidal shape having plural (n) entrance faces 761h-1 to 761h-n, the laser beams can be condensed on plural (n) condensing points FP₁ to FPₙ by providing the condenser lenses 77-1 to 77-n and 78-1 to 78-n reflecting plural laser beams at the same reflection angle as the incidence angle and condensing the reflected laser beams on the optical axes OPX₁ to OPXₙ of the reflected laser beams. By adjusting the inclination angles of the entrance faces 761h-1 to 761h-n, the optical axes OPX₁ to OPXₙ can be refracted in an arbitrary direction. For example, a triangular prism coated with a thin film of Al, MgF₂, or the like so as to totally reflect an incident laser beam can be used as the reflective highly-refractive optical element 76h. In this embodiment, similarly to the above-mentioned embodiment, the beam expander 75 may be provided in front or back of the highly-refractive optical element 76h.

### Sixth Embodiment

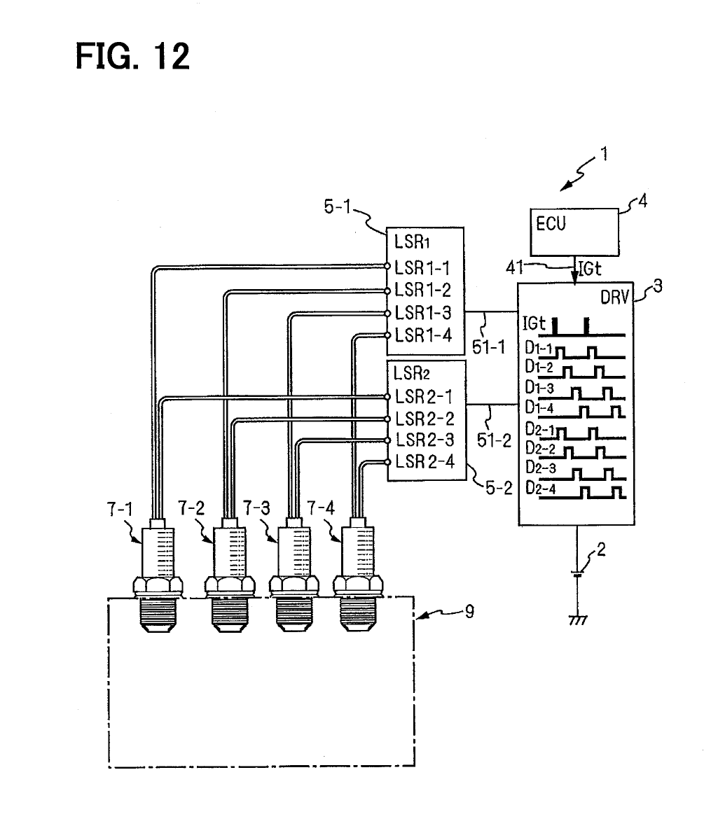

A laser ignition system 1 according to a sixth embodiment of the invention will be schematically described with reference to FIG. 12. The configuration in which one laser ignition plug 7 is provided in one engine combustion chamber is described in the above-mentioned embodiment, but a configuration in which laser ignition plugs 7-1 to 7-4 are provided in a multi-cylinder engine to correspond to the cylinders will be described. In this embodiment, the branch numbers of the laser ignition plugs 7-1 to 7-4 represent an example of the ignition order of the cylinders but do not represent the arrangement order.

The DRV 3 generates drive signals D₁₋₁, D₁₋₂, D₁₋₃, and D₁₋₄ for driving the semiconductor laser 5-1 and drive signals D₂₋₁, D₂₋₂, D₂₋₃, and D₂₋₄ for driving the semiconductor laser 5-2 so as to transmit the excitation laser beams to the laser ignition plugs 7-1 to 7-4 provided for the cylinders in the ignition order in response to the ignition signal IGt from the ECU 4, and supplies energy to the semiconductor lasers 5-1 and 5-2 in the ignition order with a predetermined time difference in response to the drive signals. The semiconductor lasers 5-1 and 5-2 sequentially transmit the excitation laser beams LSR1-1, LSR1-2, LSR1-3, LSR1-4, LSR2-1, LSR2-2, LSR2-3, and LSR2-4 generated by using the currents supplied in accordance with the drive signals D₁₋₁, D₁₋₂, D₁₋₃, D₁₋₄, D₂₋₁, D₂₋₂, D₂₋₃, and D₂₋₄ to the laser ignition plugs 7-1 to 7-4 provided for the cylinders.

### Seventh Embodiment

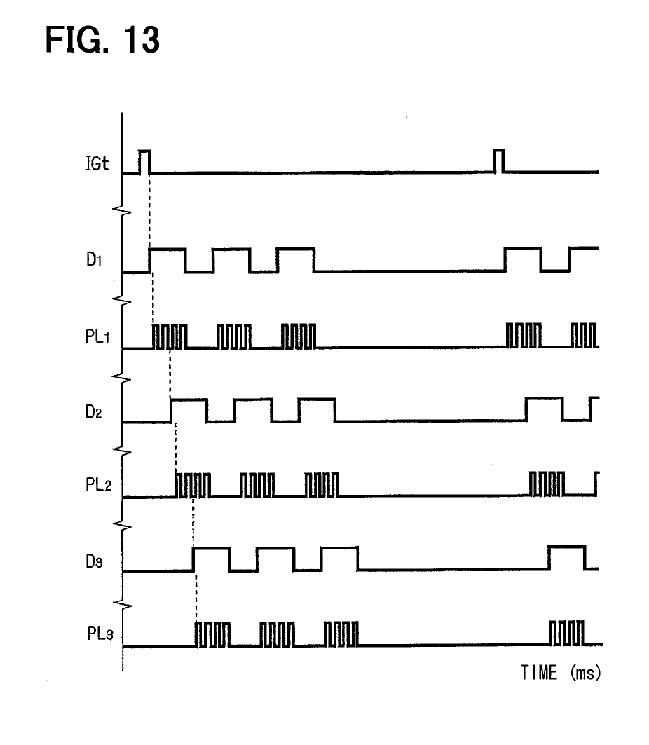

A control method of oscillating plural laser beams at different oscillation timings depending on the operating status of the internal combustion engine 9 will be described below with reference to FIG. 13 as an example of a control method of a laser ignition system according to a seventh embodiment of the invention. In this embodiment, an example where three semiconductor lasers 5-1, 5-2, and 5-3 are provided will be described. In this embodiment, the semiconductor laser driving circuit 3 is provided as an operating statue detection device for detecting the operating status of the internal combustion engine 9 and a laser oscillation control device that determines the number of oscillations and the oscillation timing of the laser beams and the number of laser beams oscillated in response to the ignition signal IGt in an ignition cycle of the laser beams PL₁, PL₂, and PL₃ oscillated from the laser oscillator 1 to the combustion chamber 900 on the basis of the detection result of the operating status detection device. The semiconductor laser driving circuit 3 provided as the laser oscillation control device controls the number of oscillations and the oscillation timing of the laser beams oscillated in response to one ignition signal by the use of an application timing and an application time period of electric energy to the semiconductor laser beams 5-1, 5-2, and 5-3.

As the operating status detection device for detecting the operating status of the internal combustion engine 9, an intake-air temperature sensor detecting an intake-air temperature, a water temperature sensor detecting an engine cooling water temperature, an oil temperature sensor detecting an engine oil temperature, a revolution sensor detecting an engine revolving speed, a crank angle sensor detecting a crank angle, an NF sensor detecting a gaseous mixture concentration, an EGR sensor detecting an EGR rate, a swirl sensor detecting a mixture flow rate, a cylinder pressure sensor detecting a cylinder pressure, and the like can be used. On the basis of the operating status detected by the operating status detection device, ignition conditions are calculated by the engine controller ECU and the ignition signal

IGt is oscillated to the semiconductor laser driving circuit 3.

The timing and the number of oscillations to oscillate the plural semiconductor laser driving circuits 3-1, 3-2, and 3-3 are determined by the ECU depending on the operating status. As shown in FIG. 13, drive signals D₁, D₂, and D₃ are oscillated plural times to the semiconductor laser driving circuits 3-1, 3-2, and 3-3 at different timings in response to a single ignition signal IGt. When the semiconductor lasers 5-1, 5-2, and 5-3 are being driven by the drive signals D₁, D₂, and D₃, excitation laser beams are oscillated from the semiconductor lasers 5-1, 5-2, and 5-3 to the resonator 74. When being greater than a predetermined threshold value, plural pulse laser beams PL₁, PL₂, and PL₃ are oscillated from the resonator 74. The number of oscillations of the excitation laser beams in response to the ignition signal IGt of one cycle can be controlled on the basis of the time width for driving the semiconductor lasers 5-1, 5-2, and 5-3 and the number of driving with respect to one ignition signal IGt. The oscillation interval of the pulse laser beams oscillated in the driving period of the semiconductor lasers 5-1, 5-2, and 5-3 can be controlled within a range of several tens of μs, because the saturation time of fluorescence energy generated in the resonator 74 can be adjusted by adjusting the current flowing in the semiconductor lasers 5-1, 5-2, and 5-3.

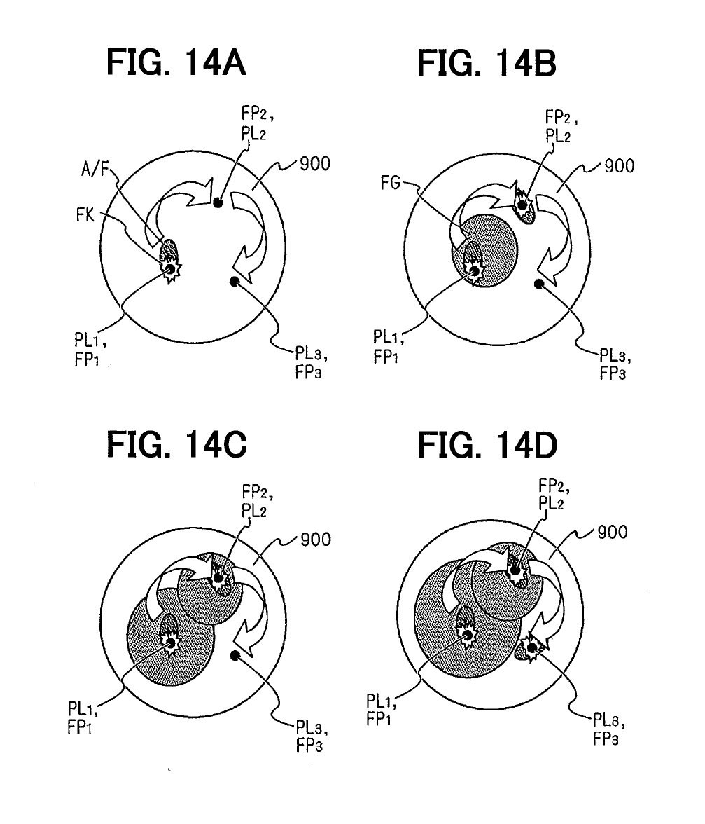

An effect when plural laser beams are condensed on plural positions in the combustion chamber 900 of the internal combustion engine 9 at different oscillation timings by the use of the laser ignition system according to the seventh embodiment will be described with reference to FIGS. 14A to 14D. When plural laser beams are condensed at the same oscillation timing unlike the present aspect and the gaseous mixture concentration in the combustion chamber 900 is not even, a difference in combustion state is present between a case where the laser beams are condensed under a hardly-ignited condition and a case where the laser beams are condensed under an easily-ignited condition and thus the effect based on the increase in the number of ignition points is reduced. For example, as sequentially shown in FIGS. 14A to 14D, under the condition that a clockwise rotating flow occurs in the combustion chamber, a first pulse laser beam PL₁ is condensed on a first condensing point FP₁, the gaseous mixture NE around the condensing point is ignited to form a flame kernel FK, the flame kernel FK moves by an air flow while growing to a grown flame FG, a second pulse laser beam PL₂ is oscillated just before the flame reaches the condensing point FP₂ of the second pulse laser beam PL₂, a third pulse laser beam PL₃ is oscillated just before a flame kernel FK formed by the second pulse laser beam PL₂ reaches the condensing point FP₃ of the third pulse laser beam PL₃, and the gaseous mixture NF around the condensing point is ignited by the third pulse laser beam PL₃ to form a flame kernel FK. In this way, the drive signals D₁, D₂, and θ₃ are controlled to sequentially form the flame kernels FK. In this way, when plural pulse lasers PL₁, PL₂, and PL₃ are oscillated at the timings at which the gaseous mixture is sequentially ignited from the upstream of the air flow, the ignition performance of the condensing point on the downstream side is enhanced by the heat of the flame FG growing from the upstream side. Accordingly, the initial flame growing speed can be increased in comparison with the case where the laser beams are simultaneously condensed on plural positions.

In general, in the laser resonator 74, heat is emitted due to the loss of the excitation laser beams in the laser medium 742 and the saturable absorber 743. However, when plural semiconductor lasers LSR₁, LSR₂, and LSR₃ are simultaneously driven to simultaneously oscillate plural excitation laser beams, the temperature of the laser medium 742 may be raised to change the refractive index and the oscillation mode (the beam intensity distribution on a cross-section of a laser beam) of the laser beams may be changed to lower the condensing height. Therefore, by intermittently driving the plural semiconductor lasers LSR₁, LSR₂, and LSR₃ as shown in FIG. 13, the rise in temperature of the laser medium 742 can be suppressed and the variation in oscillation mode can be reduced, thereby producing stable ignition. When a next laser beam is oscillated in the stage where a flame kernel formed by oscillation of one laser beam is growing, energy generated at the condensing point can be supplied to the flame and the loss of energy dissipated from the flame to the gaseous mixture can be compensated for.

When plural laser beams are simultaneously or consecutively oscillated, the energy supplied to the flame can be increased but the condensing height due to the rise in temperature of the laser medium 742 may be lowered as described above. On the other hand, when plural pulse laser beams PL₁, PL₂, and PL₃ are intermittently oscillated in response to one ignition signal IGt, the lowering of the condensing height due to the rise in temperature of the laser medium 742 can be suppressed and the energy loss can be reduced, thereby suppressing an increase in fuel efficiency. Particularly, this effect is exhibited well in conditions having lower ignition performance, such as lean mixture combustion, high EGR combustion, highly-supercharged combustion, low-compressed combustion, low-intake temperature combustion, lower oil temperature, low water temperature, and low fuel temperature.

### Eighth Embodiment

A laser ignition system 1a according to an eighth embodiment of the invention and a modified example thereof will be described below with reference to FIGS. 15A to 15C, FIGS. 16A to 16C, and FIG. 17. In this embodiment, the permeability of the saturable absorber 743 of the resonator 74 and the reflectance of the reflective film of the partial reflecting mirror 744 provided as an output mirror are partially changed to change the oscillation interval and the pulse energy of the plural pulse laser beams PL₁ and PL₂. In the resonator 74a, as shown in FIG. 15A, the permeability of saturable absorbers 743-1 and 743-2 attached to the laser medium 742 is changed for each excitation laser beam. Specifically, by changing the Cr concentration of Cr:YAG used as the saturable absorbers 743-1 and 743- 2, the permeability can be changed. When the Cr concentration is raised, the permeability is lowered. When the permeability is lowered, the pulse energy of the oscillated pulse laser beams is raised and the oscillation frequency is lowered.

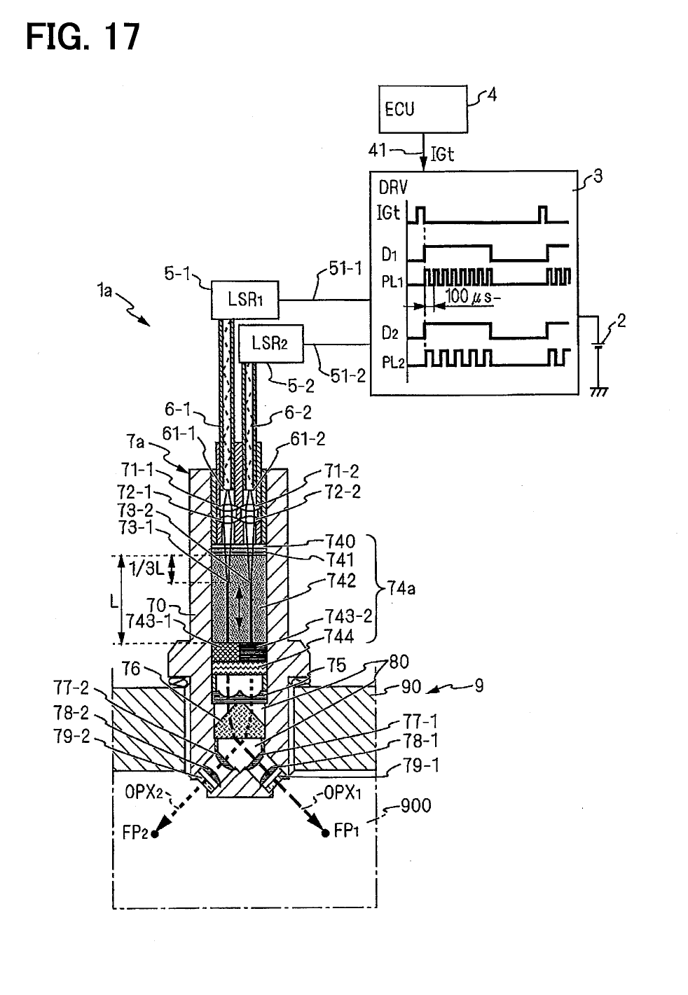

In the resonator 74b, as shown in FIG. 15B, the permeability may be changed by keeping the material constant and changing the thicknesses of the saturable absorbers 743-1 and 743-2. In the resonator 74c, as shown in FIG. 15C, the pulse energy and the oscillation frequency of the pulse laser beams PL₁ and PL₂ to be output are changed by changing the reflectance of the partial reflecting mirrors 744₍₁₎ and 744₍₂₎ without changing the saturable absorbers 743. When the reflectance of the partial reflecting mirror 744 is raised, the pulse energy oscillated is raised and the oscillation frequency is lowered. In FIGS. 16A to 16C, the resonators 74d, 74e, and 74f are partitioned for each excitation laser beam. By employing this configuration, as described above, the oscillation energy or the oscillation frequency for each excitation laser beam can be changed, the mutual influence of plural excitation laser beams can be removed, the rise in temperature of the laser medium 742 can be suppressed, and more stable pulse laser beams can be oscillated. FIG. 17 is a diagram schematically illustrating the laser ignition system 1a according to this embodiment in which the saturable absorbers 743-1 and 743-2 having permeability different for each excitation laser beam are provided. By employing this configuration, plural pulse laser beams PL₁ and PL₂ different in pulse energy and oscillation frequency can be oscillated.

The effect when the permeability which differs depending on the excitation laser beams is changed for each excitation laser beam like the laser ignition system 1a according to this embodiment will be described below. A pulse laser beam having a low oscillation frequency increases in loss in the resonator 74 and thus the efficiency is not good. However, since the oscillation energy for each pulse is high by as much, the effect is exhibited under conditions having poor ignition performance such as a case where the mixture concentration is low or a case where an air flow is rapid and the flame kernel easily disappears. On the other hand, when the oscillation frequency is high, the loss in the resonator 74 is low and the efficiency is high. Since the energy for each pulse is low but the number of oscillations is large, the total energy is high and the same energy as in the case where the oscillation frequency is low can be supplied. A pulse laser beam having a high oscillation frequency can be effectively used in regions with a relatively low load in which the mixture concentration is high, the flow rate is low, and the fuel efficiency is considered to be important. In this way, by changing the permeability or the like of the resonator when oscillating plural pulse laser beams to plural positions of the combustion chamber, plural pulse laser beams having pulse energy and oscillation frequency of different specifications can be oscillated from a single laser ignition system 1a and enhancement in both ignition performance and fuel efficiency can be achieved, thereby raising the degree of freedom as an ignition system.

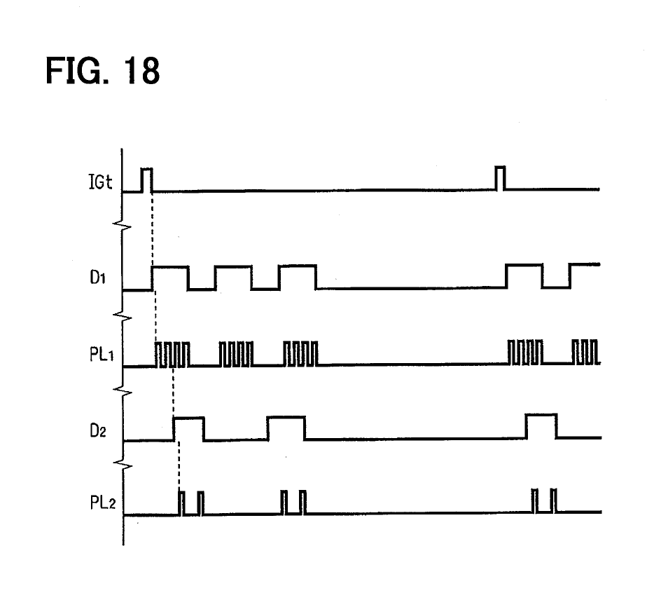

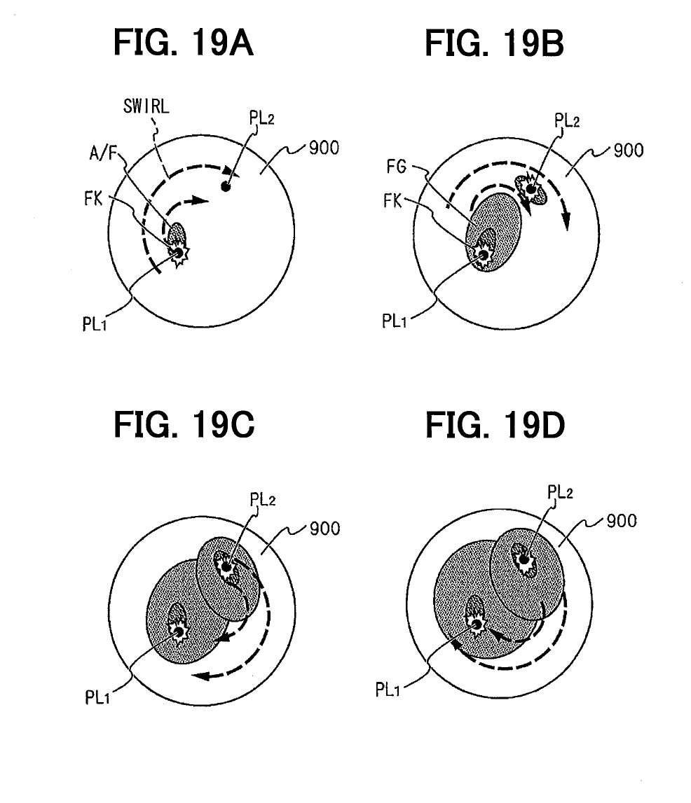

An example of a control method of the laser ignition system 1a according to the eighth embodiment and the effect thereof will be described below with reference to FIG. 18 and FIGS. 19A to 19D. In this embodiment, by changing the permeability of the resonator 74 or the like for each excitation laser beam as described above, pulse laser beams PL₁ and PL₂ having different pulse energy and oscillation frequency are oscillated. At this time, as shown in FIG. 18, a first drive signal D₁ having a short oscillation interval and a second drive signal D₂ having a long oscillation interval are oscillated in response to the ignition signal IGt oscillated in one ignition cycle, and a first pulse laser beam PL₁ having a high oscillation frequency and low pulse energy and a second pulse laser beam PL₂ having a low oscillation frequency and high pulse energy are oscillated.

In this embodiment, as shown in FIGS. 19A to 19D, the first pulse laser beam PL₁ having a high oscillation frequency and low pulse energy is condensed on the region in which the flow rate of a swirl generated as a cylinder air flow is low and the mixture concentration is high, and the second pulse laser beam PL₂ having a low oscillation frequency and high pulse energy is condensed on the region in which the swirl flow rate is high and the mixture concentration is low. By employing this configuration, the region in which the swirl flow rate is low and the mixture concentration is high has relatively good ignition performance and thus is efficiently ignited with the first pulse laser beam PL₁ having low pulse energy. Since the region in which the swirl flow rate is high and the mixture concentration is low has poor ignition performance, the flame kernel FK formed by the first pulse laser beam PL₁ approaches the condensing point of the second pulse laser beam PL₂ while growing. Accordingly, enhancement in ignition performance can be achieved and a region having poor ignition performance can be rapidly ignited with the second pulse laser beam PL₂ having high pulse energy. Therefore, the fall in temperature of the flame formed by the first pulse laser PL₁ due to a strong swirl can be suppressed and the consecutive combustion can be achieved due to the second pulse laser beam PL₂, thereby producing stable ignition even in an internal combustion engine having a large bore diameter or an internal combustion engine such as a highly-supercharged and highly-compressed engine having an ignition-retardant property.

### Ninth Embodiment

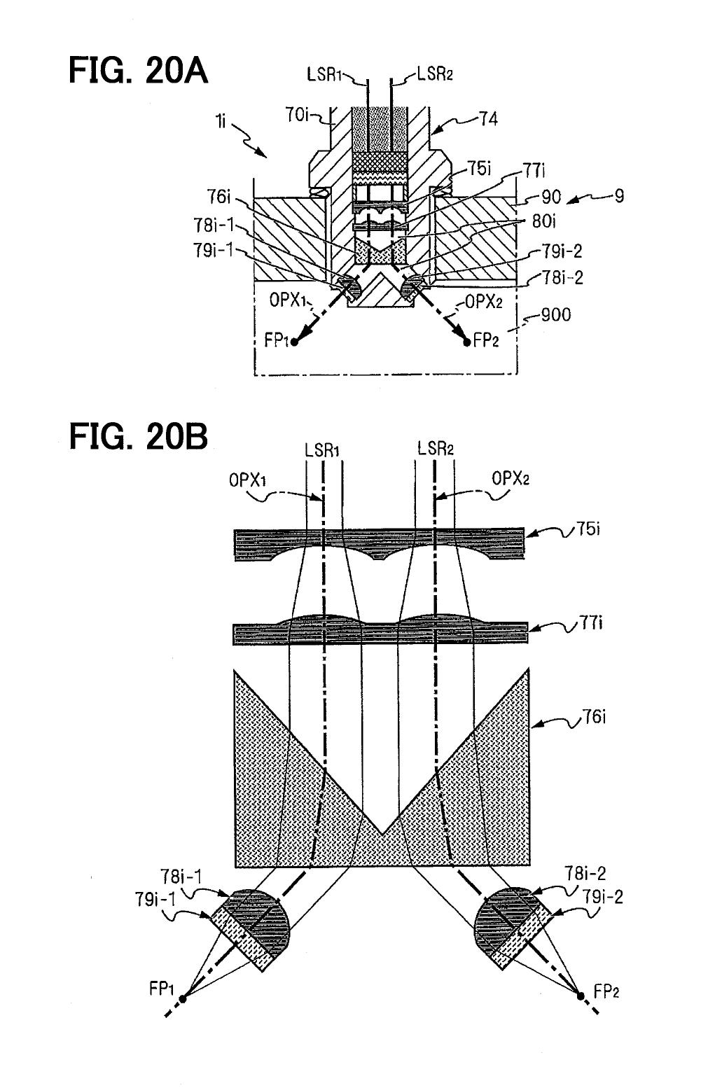

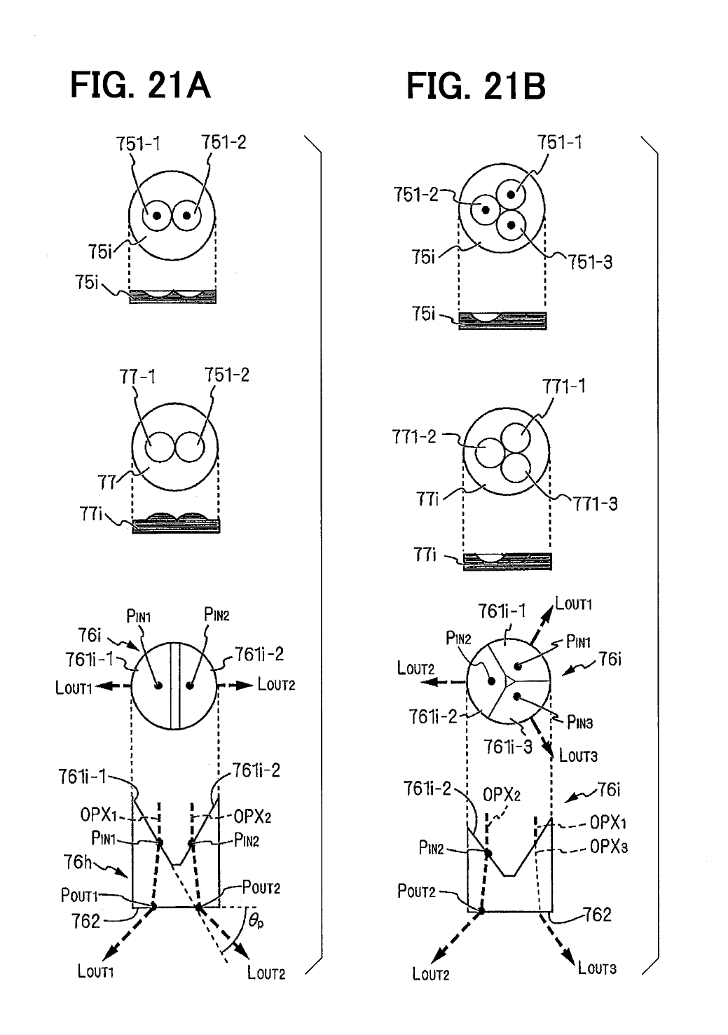

A laser ignition system 1i according to a ninth embodiment of the invention will be described below with reference to FIGS. 20A and 20B and FIGS. 21A to 21D. The above-mentioned embodiment states the example where when the directions of the optical axes OPX₁ to OPXₙ of the plural pulse laser beams PL₁ to PLₙ which are excited by the plural semiconductor laser beams LSR₁ to LSRₙ oscillated from the laser oscillator 5 are changed using the highly-refractive optical element 76 having a substantially polygonally pyramidal shape, the pulse laser beams are once directed to the central axis of the ignition plug 7, are then refracted to get away from the central axis, and form condensing points FP-1 to FP-n at plural positions in the engine combustion chamber 900 by using the condenser lenses 77-1 to 77-n and 78-1 to 78-n provided at an end thereof. However, in the laser ignition system 1i according to this embodiment, the center of the highly-refractive optical element 76i is made to be concave in a substantially polygonally pyramidal shape and the plural pulse laser beams PL₁ and PL₂ incident on the entrance face 761i are refracted to get away from the central axis without intersecting each other. The above-mentioned embodiment states the example where the pulse laser beams PL₁ and PL₂ oscillated from the resonator 74 are expanded in beam diameter by the beam expander 75, are refracted in the optical axes OPX₁ and OPX₂ by the highly-refractive optical element 76, and are condensed by the plural condenser lenses 77 and 78. However, in this embodiment, after the beam diameter is expanded by the beam expander 75, the pulse laser beams are adjusted to parallel beams by the condenser lens (convex lens) 77i and are then made to pass through the highly-refractive optical element 76i.

In this embodiment, as shown in FIGS. 21A and 21B, the number of beam expanders 75i, the number of condenser lenses 77i, and the number of entrance faces 761i-1 to 761i-n of the highly-refractive optical element 76i can be arbitrarily changed and mounted depending on the number of laser beams. According to this embodiment, since plural pulse laser beams are condensed in the combustion chamber without intersecting each other, erroneous ignition due to pseudo condensing based on mutual interference or intersection of plural laser beams is not caused.

### Tenth Embodiment

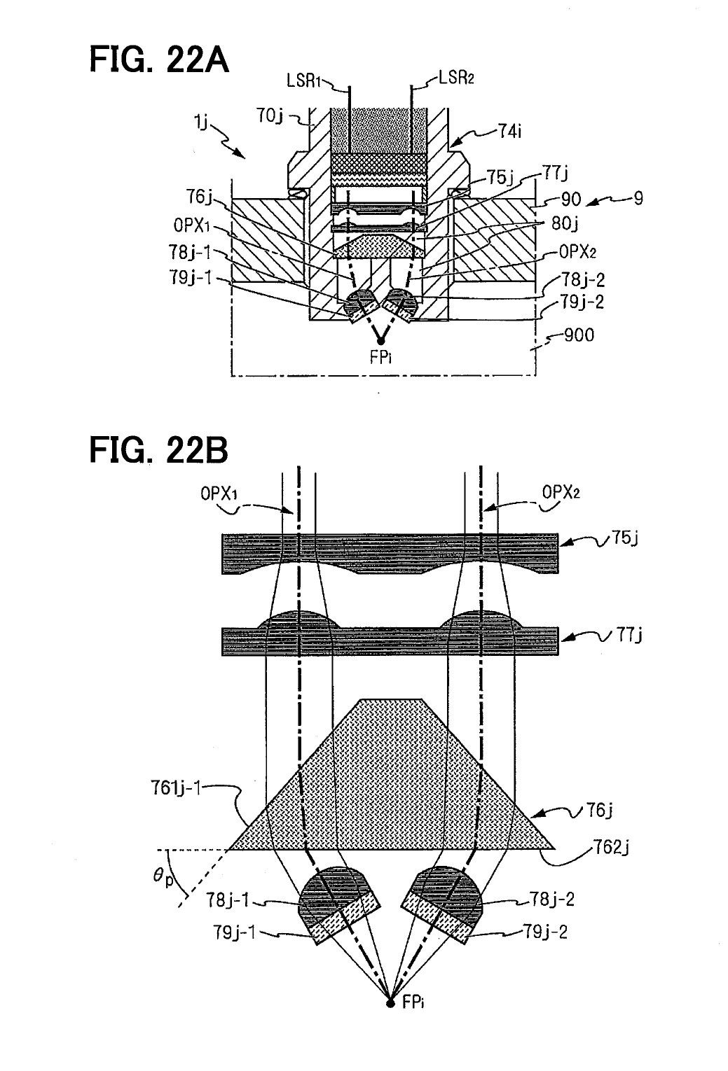

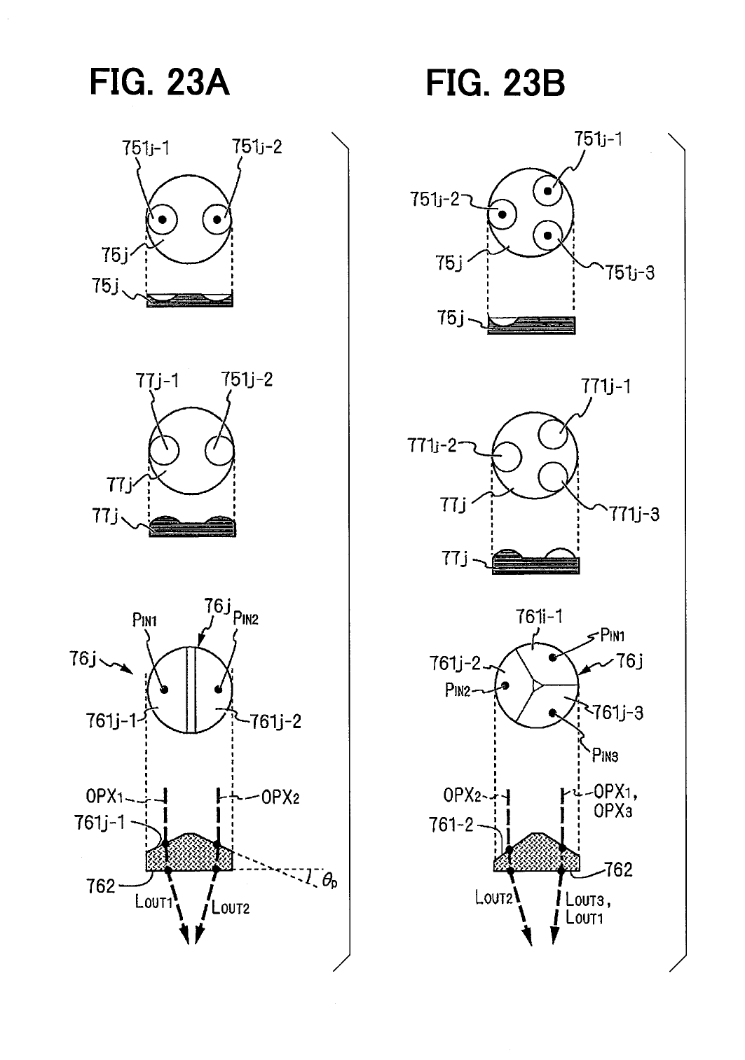

A laser ignition system 1j according to a tenth embodiment will be described below with reference to FIGS. 22A and 22B and FIGS. 23A and 23B. The above-mentioned embodiment states the configuration in which the enhancement in ignition performance is achieved by condensing plural pulse laser beams PL₁ to PLₙ on plural condensing points FP₁ to FPₙ in the combustion chamber 900 by using the highly-refractive optical elements 76 and 76a to 76i. However, as described in this embodiment, the optical axes OPX₁ and OPX₂ of plural pulse laser beams PL₁ to PLₙ may be refracted by the highly-refractive optical element 76j to change traveling directions thereof to directions in which the pulse laser beams converge on one position, and the plural pulse laser beams PL₁ to PLₙ may be intensively condensed on one point FPi in the combustion chamber 900 by using the condenser lens 78i provided at an end thereof. By employing this configuration, high energy for maintaining the combustion can be effectively supplied even when the flow rate of a gaseous mixture in the combustion chamber 900 is high and the variation in mixture concentration is large.

In this embodiment, as shown in FIGS. 23A and 23B, the number of beam expanders 75j, the number of condenser lenses 77j, and the number of entrance faces 761j-1 to 761j-n of the highly-refractive optical element 76j can be arbitrarily changed and mounted depending on the number of laser beams.

In the above-mentioned embodiments, when the semiconductor laser driving circuit 3 is controlled to supply a current to the semiconductor laser oscillator 5 in response to the ignition signal IGt oscillated from the engine ECU 4 depending on the operating status of the engine, the laser beams are condensed on the condensing points FP in the embodiments, the laser beams are absorbed by the gaseous mixture around the condensing points (absorption of multiple photons), and thermal separation of the gaseous mixture is caused to start combustion. When the current is consecutively supplied to the semiconductor laser oscillator 5, the laser beams are repeatedly oscillated at intervals of about 100 to 300 μs, the thermal separation is maintained, thereby consecutively spreading flames. The positions of the condensing points are determined to maximize the flame spread speed depending on the shape of the engine combustion chamber and the operating status of the internal combustion engine employing the laser ignition system. For example, in an engine having a large bore diameter, when a laser beam is traveling in a gaseous mixture, a pseudo lens may be formed due to the density difference of the gaseous mixture to cause a fall in condensing intensity due to scattering of the laser beam. Accordingly, it is preferable that the refractive index of the highly-refractive optical element 76 and the prism vertex angle θₚ are set to condense the laser beam on a position close to the inner peripheral wall of a cylinder. On the other hand, in an engine having a relatively small bore diameter and having a strong flow formed in a cylinder, it is preferable that plural condensing points be concentrated on positions close to the center of the combustion chamber. According to this embodiment, simultaneous start of ignition at plural condensing points in the engine combustion chamber or sequential start of multiple ignition at different timings can be arbitrarily selected.

Generally, in a laser ignition system, a time delay of about 150 to 200 μs is present after turning on the semiconductor laser 5 until starting the oscillation of pulse laser beams PL₁ to PLₙ. Accordingly, the current application start timing is determined to optimize the ignition timing by predicting the time delay. The oscillation interval when multiple ignition is performed can be controlled on the basis of the power applied to the semiconductor laser 5. When the oscillation interval is short, the oscillation interval can be controlled by raising the current value. The current application start timing and the current value to the plural semiconductor lasers 5-1 to 5-n may be independently controlled. It is preferable that a laser beam, which has a short pulse oscillation period and small pulse energy, out of plural pulse laser beams PL₁ to PLₙ be arranged in a region having a slow cylinder flow in the engine combustion chamber 900 of the internal combustion engine. According to this embodiment, since the condensing points can be arranged in arbitrary regions in the cylinder by using the setting of the relative refractive index n_{ab} of the highly-refractive optical element 76 and the prism vertex angle θₚ and the selection of the condensing distance of the condenser lenses 77 and 78, combustion control with a very high degree of freedom is possible and thus a laser ignition system exhibiting very excellent ignition performance in an ignition-retardant combustion engine can be realized.

While the invention has been described with reference to specific embodiments, the embodiments are merely exemplary and it will be understood by those skilled in the art that various modified examples, corrected examples, alternative examples, substituted examples, and the like are possible. The systems according to the embodiments have been described with reference to functional block diagrams for the purpose of convenient explanation, but such systems may be embodied by hardware, by software, or by combination thereof. The invention is not limited to the above-mentioned embodiments, but includes various modified examples, corrected examples, alternative examples, and substituted examples without departing from the spirit of the invention.

While the invention has been described with reference to the exemplary embodiments, it should be understood that the invention is not limited to the exemplary embodiments or the structures thereof. The invention is intended to include various modified examples or equivalent arrangements thereof. In addition, various combinations or configurations in which the numbers of elements increase or decrease belong to the scope and spirit of the invention.

1-8. (canceled)

9. A laser ignition system that is mounted on an internal combustion engine and that condenses a laser beam oscillated from a laser oscillator into an engine combustion chamber by using a condenser lens to generate a flame kernel with high energy and to perform ignition, comprising:
a highly-refractive optical element that refracts optical axes of a plurality of laser beams, which are oscillated from a plurality of semiconductor lasers through a resonator, to change traveling directions of the laser beams to directions in which the laser beams get away from a central axis; and
a condenser device that condenses the laser beams refracted by the highly-refractive optical element on a plurality of positions in the engine combustion chamber,
wherein a plurality of excitation beams are incident on the resonator, in which a total reflecting mirror, a laser medium, a saturable absorber, and a partial reflecting mirror are formed as a unified body, to cause a plurality of pulse laser beams to exit from the resonator, and
wherein an optical system enlarging a radiation angle of a latter laser beam of each laser, the highly-refractive optical element refracting the laser beams, the condenser lens, and a reinforcing glass are housed in a single chassis to condense the plurality of laser beams into the engine combustion chamber.

10. The laser ignition system according to claim 9, wherein an oscillation timing and a number of pulses of the pulse laser beams of the plurality of lasers are independently controlled to control an oscillation timing, an excitation time, and an excitation intensity of the excitation beams in a same cycle.

11. The laser ignition system according to claim 9, wherein the highly-refractive optical element is formed of a highly-refractive polyhedron in which a predetermined vertex angle is formed between a plurality of faces on which the plurality of laser beams are incident and a face from which laser beams refracted by a predetermined refraction angle exit, and
wherein the resonator includes the laser medium, which is excited by the semiconductor laser, and the saturable absorber and partially changes permeability of the saturable absorber.

12. The laser ignition system according to claim 9, wherein the highly-refractive optical element is a reflective optical element that reflects a laser beam by a high-reflectance reflective film provided on its surface and is formed of a polyhedron, on which the plurality of laser beams are incident at predetermined incidence angles and that totally reflects the plurality of laser beams at the same reflection angles as the incidence angles, and
wherein a laser beam, which has a short pulse oscillation period and small pulse energy, out of the plurality of laser beams is arranged in a region having a slow cylinder air flow in the engine combustion chamber of the internal combustion engine.

13. The laser ignition system according to claim 9, further comprising:
an operating status detection device for detecting an operating status of the internal combustion engine; and
a laser oscillation control device that determines a number of oscillations, an oscillating timing, and a number of laser beams in one ignition cycle of the laser beams, oscillated from the laser oscillator into the engine combustion chamber, based on a detection result of the operating status detection device.

14. The laser ignition system according to claim 13, wherein the laser oscillation control device controls the number of oscillations and the oscillation timing in one ignition cycle based on an application timing and an application time period of electric energy to the semiconductor laser.

15. The laser ignition system according to claim 9, wherein the resonator includes the laser medium, which is excited by the semiconductor laser, and the saturable absorber and partially changes permeability of the saturable absorber.

16. The laser ignition system according to claim 9, wherein a laser beam, which has a short pulse oscillation period and small pulse energy, out of the plurality of laser beams is arranged in a region having a slow cylinder air flow in the engine combustion chamber of the internal combustion engine.
